(19) United States
(12) Patent Application Publication
(10) Pub. No.: US 2013/0287122 A1
(43) Pub. Date: Oct. 31, 2013

(54) VIDEO TRANSMISSION DEVICE, VIDEO TRANSMISSION METHOD, VIDEO RECEIVING DEVICE, AND VIDEO RECEIVING METHOD

(71) Applicants: Hiroki Mizosoe, Kawasaki (JP); Manabu Sasamoto, Yokohama (JP); Hironori Komi, Tokyo (JP); Mitsuhiro Okada, Yokohama (JP)

(72) Inventors: Hiroki Mizosoe, Kawasaki (JP); Manabu Sasamoto, Yokohama (JP); Hironori Komi, Tokyo (JP); Mitsuhiro Okada, Yokohama (JP)

(73) Assignee: HITACHI CONSUMER ELECTRONICS CO., LTD., Tokyo (JP)

(21) Appl. No.: 13/884,808

(22) PCT Filed: Jan. 20, 2012
(86) PCT No.: PCT/JP2012/000331

§ 371 Date: Jun. 21, 2013

(30) Foreign Application Priority Data
Mar. 9, 2011 (JP) 2011-050973
Mar. 9, 2011 (JP) 2011-050975
Mar. 17, 2011 (JP) 2011-058665

(51) Int. Cl. H04N 7/26

(52) U.S. Cl. CPC H04N 19/00545
USPC 375/240.26

(57) ABSTRACT

A video transmission device comprising: a reference signal generation unit which generates a reference signal based on time information; an imaging unit which images a video signal based on the reference signal generated by means of the reference signal generation unit; a compression unit which performs digital compression encoding of the video signal imaged by means of the imaging unit; a network processing unit which receives, from a network, time information and phase information about a reference signal in regard to the time information and, also, transmits the digital compression encoded video signal; and a control unit which controls the reference signal generation unit and the network processing unit. Here, the control unit modifies the phase of the reference signal generated with the reference signal generation unit in response to the time information and the phase signal received with the network processing unit.

### TECHNICAL FIELD

The present invention pertains to a device transmitting video images.

### BACKGROUND ART

Regarding the aforementioned technical field, there is, e.g. in Patent Literature 1, disclosed a communication device that has a function of adjusting the display time when communicating video images via a network.

### CITATION LIST

### Patent Literature

### Patent Literature 1: JP-A-09-51515

### SUMMARY OF INVENTION

### Technical Problem

However, as for the art described in Patent Literature 1, there has been the problem that the processing on the video reception side for simultaneously displaying video images received from a plurality of video transmission devices becomes complex.

### Solution To Problem

Accordingly, in the present description, there is e.g. chosen a configuration in which a video transmission device controls the output delay time thereof in response to the control of a video reception device.

### Advantageous Effects Of Invention

According to the present invention, it is possible to furnish a video communication system taking into account output delay times.

### BRIEF DESCRIPTION OF DRAWINGS

FIG. 1 is a diagram showing an example of a video communication system including a video transmission device and video reception device.

FIG. 2 is a diagram showing an example of internal block configuration of a video transmission device.

FIG. 3 is a diagram showing an example of the digital compression processing of a video transmission device.

FIG. 4 is a diagram showing an example of a digital compressed video signal of a video transmission device.

FIG. 5 is a diagram showing an example of a packet of digital compressed video signals.

FIG. 6 is a diagram showing an example of LAN packets of a video transmission device.

FIG. 7 is a diagram showing an example of an internal block configuration of a video reception device.

FIG. 8 is a diagram showing another example of an internal block configuration of a video reception device.

FIG. 9 is a diagram showing an example of a flowchart of the delay time check process of a video reception device.

FIG. 10 is a diagram showing an example of a flowchart of the delay time response process of a video transmission device.

FIG. 11 is a diagram showing an example of a flowchart of a delay time setting process of a video reception device.

FIG. 12 is a diagram showing an example of a flowchart of a delay time setting process of a video transmission device.

FIG. 13 is a diagram showing an example of transmission process timings of a video transmission device and reception process timings of a video reception device.

FIG. 14 is a diagram showing another example of transmission process timings of a video reception device and reception process timings of a video reception device.

FIG. 15 is a diagram showing another example of transmission process timings of a video reception device and reception process timings of a video reception device.

FIG. 16 is a diagram showing another example of a block configuration of a video transmission device.

FIG. 17 is a diagram showing an example of a protocol for carrying out time synchronization.

FIG. 18 is a diagram describing an example of timings of a synchronization phase adjustment packet.

FIG. 19 is a diagram describing an example of transitions of the encoded signal storage volume of a video transmission device.

FIG. 20 is a diagram showing another example of a block configuration of a video reception device.

FIG. 21 is a diagram describing an example of transitions of the encoded signal storage volume of a video reception device.

FIG. 22 is a diagram showing another example of control timings of each block.

FIG. 23 is a diagram showing another example of a work flow of a video transmission device.

FIG. 24 is a diagram showing another example of a work flow of a video reception device.

FIG. 25 is diagram showing an example of a network camera system.

FIG. 26 is a diagram showing another example of a block configuration of a video reception device.

FIG. 27 is a diagram showing another example of transmission process timings of a video transmission device and reception process timings of a video reception device.

FIG. 28 is a diagram showing another example of a flowchart of a delay time setting process of a video reception device.

FIG. 29 is a diagram showing another example of transmission process timings of a video transmission device and reception process timings of a video reception device.

FIG. 30 is a diagram showing another example of transmission process timings of a video transmission device and reception process timings of a video reception device.

### DESCRIPTION OF EMBODIMENTS

### Embodiment 1

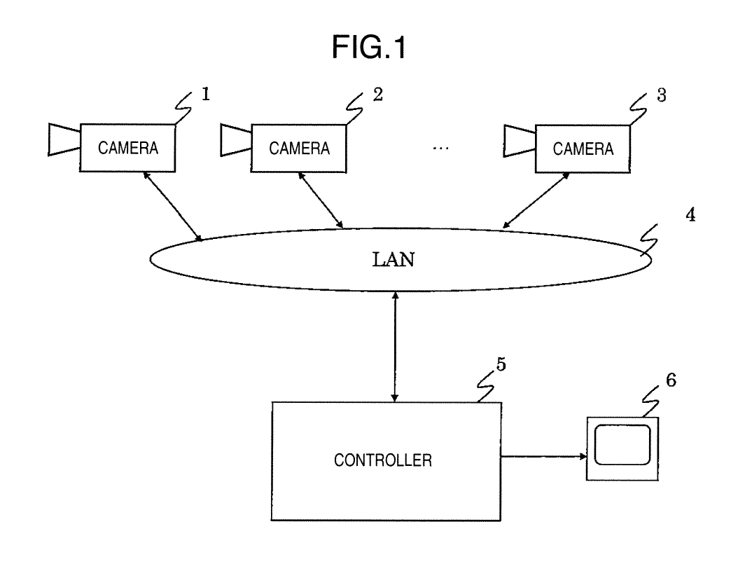

FIG. 1 is an example of an embodiment of a video communication system including cameras which are video communication devices. In FIG. 1, Ref. 1 designates a camera and Refs. 2 to 3 designate separate cameras. Ref. 4 designates a Local Area Network (LAN) and Ref 5. designates a controller, cameras 1 to 3 being connected with controller 5 via LAN 4. Ref. 6 designates a display. In the network, there may, as the used protocol, e.g. be used the method defined in the IEEE (Institute of Electrical and Electronics Engineers) 802.3 Standard which is a data link protocol, but it is further acceptable to use the IP (Internet Protocol) network protocol and to use TCP (Transmission Control Protocol) and UDP (User Datagram Protocol) for the higher-level transport protocols thereof. For video and audio communication, there is used a higher-level application protocol, such as e.g. RTP (Real-time Transport Protocol) or HTTP (Hyper Text Transfer Protocol). Additionally, a protocol method defined in the IEEE 802.3 Standard may be used. Controller 5 receives video or audio data delivered from each of the cameras and respectively outputs video images and sound to display 6 and speakers 7. As a configuration of LAN 4, a mode in which the respective cameras and controller 5 are respectively directly connected one-on-one is e.g. possible, or a connection of two or fewer cameras, or four or more cameras, connected via a not illustrated switching hub, is also possible.

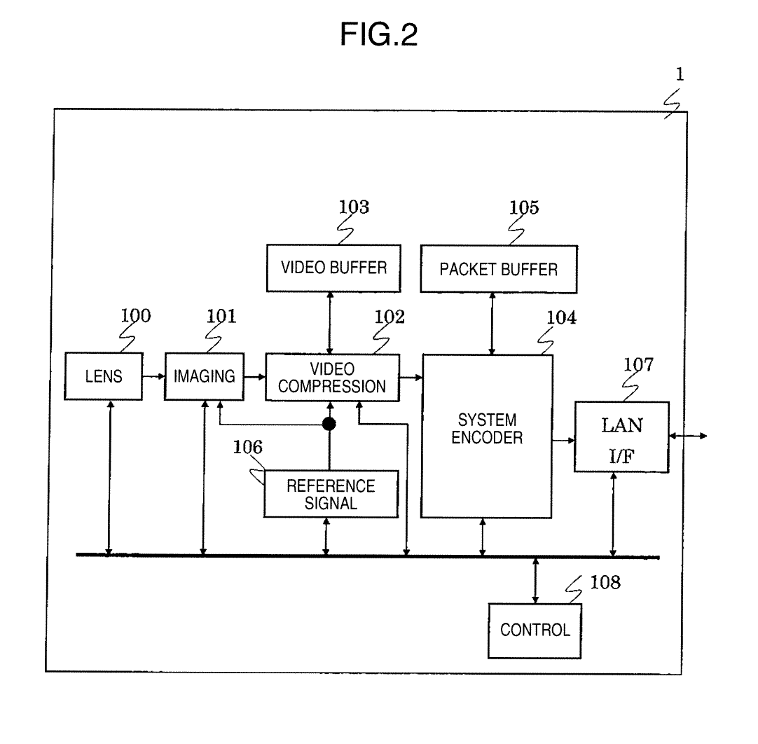

FIG. 2 is a diagram showing an example of an internal block configuration of camera 1 which is a video communication device. Ref. 100 designates a lens, Ref. 101 an imaging element, Ref. 102 a video compression circuit, Ref. 103 a video buffer, Ref. 104 a system encoder, Ref. 105 a packet buffer, 106 a reference signal generation circuit, Ref. 107 a LAN interface circuit, Ref. 108 a control circuit, and Ref. 109 a memory.

The video signal obtained in imaging element 101 via lens 100 is input into video compression circuit 102, has its color tone and contrast compensated, and is stored in video buffer 103. Next, video compression circuit 102 reads out the data stored in video buffer 103 and generates video compression encoded data compliant with e.g. the ISO (International Standards Organization)/IEC (International Electrotechnical Commission) 13818-2 (commonly known as MPEG-2 (Moving Pictures Expert Group) Video) MP@ML (Main Profile @ Main Level) Standard as the video compression encoding method. Additionally, as a video compression encoding method, the H.264/AVC (Advanced Video Coding) Standard method or the JPEG (Joint Photographic Experts Group) Standard method may be used. Also, it is acceptable for cameras of different video compression encoding methods to coexist or one camera may select and switch between video compression encoding methods. The generated video compression encoded data is input into system encoder 104. Reference signal generation circuit 106 supplies, to imaging element 101 and video compression circuit 102, e.g. a frame pulse indicating the delimitation of a video signal frame as a reference signal serving as the reference of process timings of imaging element 101 and video compression circuit 102. In accordance with this reference signal, imaging of video images by the imaging element, compression of imaged elements, and the (subsequently described) transmission of compressed video images are carried out. This reference signal is a signal that is synchronized among each of the cameras, there being, as a synchronization method, e.g. the method of inputting the synchronization signal of one camera into the other cameras.

Next, the compression encoded video data input into system encoder 104 are packetized, as shown below.

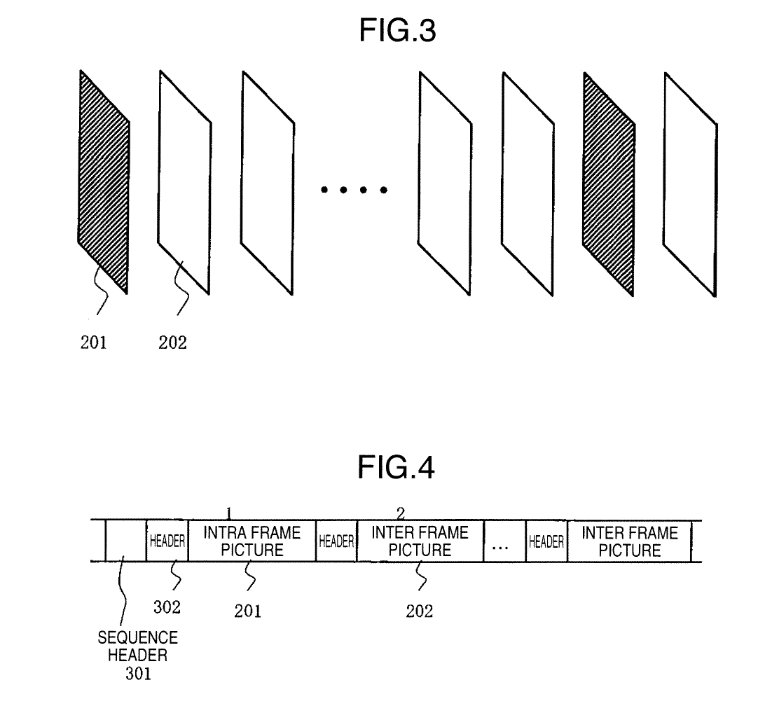

FIG. 3 is an example of digital compression processing and indicates the relationship between intra-frame data compressed in units of digital compressed video signal frames and inter-frame data on which there has been carried out compression of difference information only, using a prediction from the previously mentioned frame data. Ref. 201 designates an intra frame and Ref. 202 designates an inter frame. As for the digital compressed video signal, taking a prescribed number of frames, e.g. 15 frames, to be one sequence, the head thereof is taken to be an intra frame and the remaining frames are taken to be inter frames compressed using a prediction from the intra frame. Of course, the system may be devised so that the intra frame is arranged at a position other than the head. Also, it is acceptable to take only the head frame to be an intra frame and all the following frames to be inter frames or to take all the frames to be intra frames.

FIG. 4 shows the structure of a digital compressed video signal. Ref. 302 designates a picture header added to a frame as a unit and Ref. 301 designates a sequence header added to a sequence as a unit. Sequence header 301 is constituted by a synchronization signal and information such as the transmission rate. Picture header 302 is constituted by a synchronization signal and identification information as to whether what is concerned is an intra frame or an inter frame, and the like. Normally, the length of each data item is modified by the information volume. This digital video compressed signal is divided up into transport packets, described later, and becomes a string of packets.

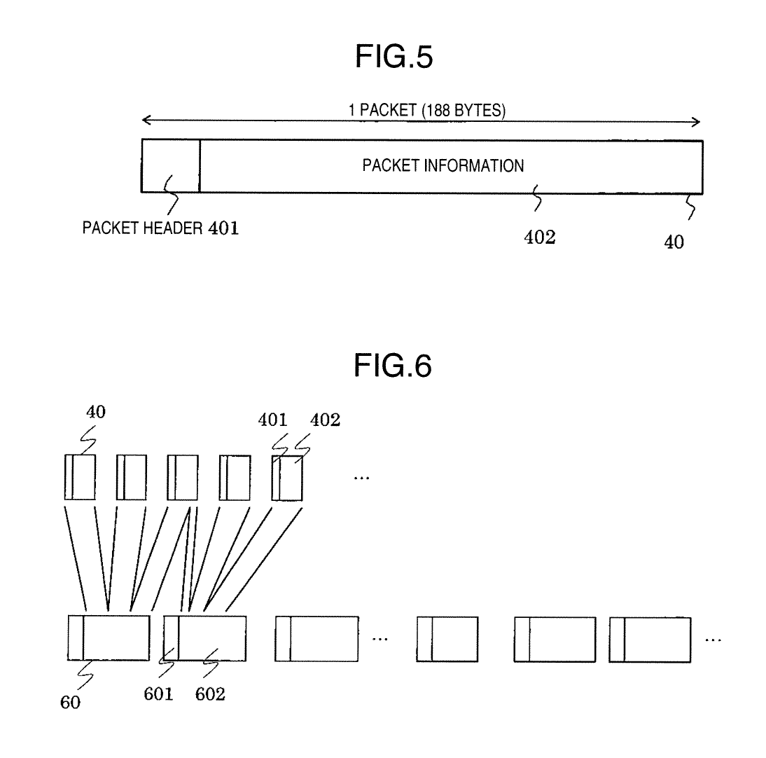

FIG. 5 is a configuration example of a transport packet of a digital video compressed signal. Ref. 40 designates a transport packet thereof, one packet having a fixed length, e.g. being constituted by 188 bytes, and is constituted by a packet header 401 and packet information 402. The digital compressed video signal described in FIG. 4 is arranged to be divided into packet information 402 areas and, in addition, packet header 401 is constituted by information such as packet information class.

The digital video compressed signal that is packetized by system encoder 104 is temporarily stored in packet buffer 105 and the packet string read out from packet buffer 105 is input into LAN interface circuit 107.

In the LAN interface circuit of FIG. 2, the input packet string is packetized into a LAN packet compliant with e.g. the IEEE 802.3 Standard and output.

FIG. 6 is a diagram showing an example of LAN packetization of a packet string generated by system encoder 104. A LAN packet 60 has a variable length with a maximum of e.g. 1518 bytes in one packet and is constituted by a LAN packet header 601 and a LAN packet information item 602. As for transport packet 40 generated by system encoder 106, there gets added, according to the previously mentioned network protocol, a LAN packet header 601 in which LAN 4-associated address information et cetera for identifying each camera is stored, together with data error correction code being stored in an area of LAN packet information item 602 and the same is output to the LAN as LAN packet 60.

Also, in LAN interface circuit 107, there is carried out exchange of control information with equipment connected with LAN 4. This is carried out by storing information such as instructions from control circuit 108 in LAN packet information item 602 and transmitting the same on LAN 4 or by extracting information from LAN packet information item 602 of LAN packet 60 received from LAN 4 and communicating the same to control circuit 108.

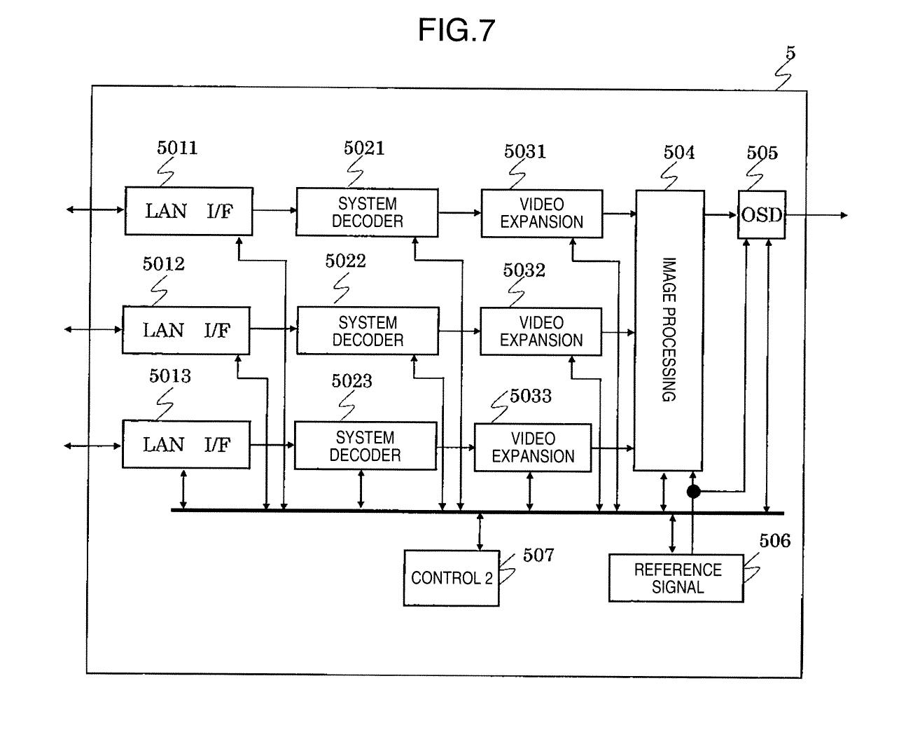

FIG. 7 is a diagram showing an example of an internal block configuration of controller 5. Refs. 5011 to 5013 designate LAN interface circuits, Refs. 5021 to 5023 system decoders, Refs. 5031 to 5033 video expansion circuits, Ref. 504 an image processing circuit, Ref. 505 an OSD (On-Screen Display) circuit, 506 a reference signal generation circuit, Ref. 507 a control circuit, and Ref. 508 a memory.

In the description of FIG. 7, system decoders 5021 to 5023, video expansion circuits 5031 to 5033, and image processing circuit 504 are described as hardware. However, by deploying, in memory 508, programs having functions corresponding respectively to those of control circuit 507 and executing the same, it is possible to implement each of the functions in software as well. Hereinafter, for the purposes of simplifying the description, a description will be given, including the case in which control circuit 507 executes programs corresponding to each of the functions, as if system decoders 5021 to 5023, video expansion circuits 5031 to 5033, and image processing circuit 504 execute the respective processes as operating cores.

LAN packets 60 generated in cameras 1 to 3 are input respectively to LAN interface circuits 5011 to 5013. LAN packets 60 input from camera 1 get LAN packet header 601 removed in LAN interface circuit 5011 and, according to the aforementioned network protocol, transport headers 40 are extracted from LAN packet data items 602. Transport packets 40 are input into system decoder 5021 and aforementioned packet information items 402 are extracted from transport packets 40 and combined to become the digital compressed video signal shown in FIG. 4. This digital compressed video signal undergoes expansion processing in video expansion circuit 5031 and is input into image processing circuit 504 as a digital video signal. Also regarding LAN packets 60 input from cameras 2 and 3, the same processing is carried out and digital video signals from video expansion circuits 5032 and 5033 are input into the image processing circuit. In image processing circuit 504, there is conducted distortion compensation, point of view conversion based on coordinate substitution, synthesis processing, and the like, of the video signals from each of the cameras and there is an output to OSD circuit 505, or, alternatively, there is carried out image processing such as object shape recognition and distance measurement based on the video signals from each of the cameras. In OSD circuit 505, characters and patterns in the video signal from image processing circuit 504 are weighted and output to display 6.

Reference signal generation circuit 506 supplies a frame pulse indicating the delimitation of e.g. video signal frames to image processing circuit 504 and OSD circuit 505, as a reference signal serving as the process timing reference of image processing circuit 504 and OSD circuit 505. This reference signal is generated taking as reference e.g. a point in time at which one frame's worth of video expansion processing has reached completion, the adjustment of the reference signal being carried out by control circuit 507's controlling reference signal generation circuit 506.

In addition, in LAN interface circuits 5011 to 5013, in order to carry out the exchange of information for the control of each camera, information such as instructions from control circuit 507 is stored in LAN packet information items 602 and the information from LAN packet information items 602 of LAN packets 60 transmitted to, or received from, each of the cameras is extracted and communicated to control circuit 507.

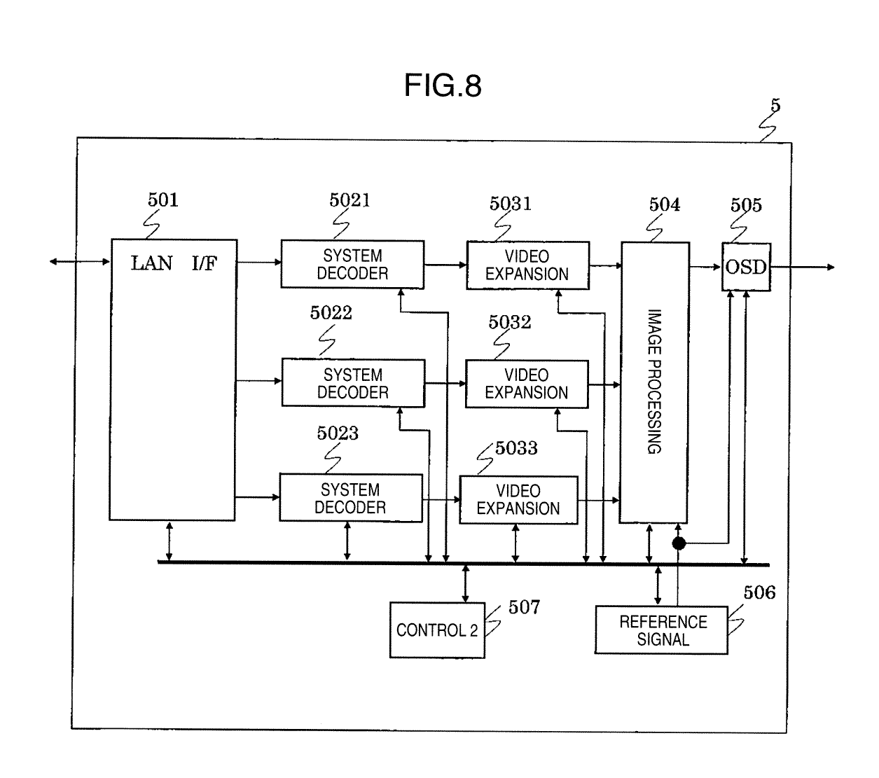

FIG. 8 is a diagram showing another example of an internal block configuration of controller 5. Ref. 501 designates a LAN interface circuit, and is connected with cameras 1 to 3 via a switching hub device, not illustrated. In LAN interface circuit 501, LAN packets from each of the cameras are distinguished, from the address information stored in aforementioned LAN packet header 601, and according to the aforementioned network protocol, transport packets 40 extracted from LAN packet information items 602 of LAN packets 60 are assigned to system decoders 5021 to 5023 and output. Processing subsequent to that of system decoders 5021 to 5023 is the same as in the description of FIG. 7.

Also, in LAN interface circuit 501, in order to carry out exchange of information for the control related with each of the cameras, information such as instructions from control circuit 507 is stored in LAN packet information items 602 and is transmitted to each of the cameras or information is extracted from LAN packet information items 602, of LAN packets 60 received from each of the cameras, and communicated to control circuit 507.

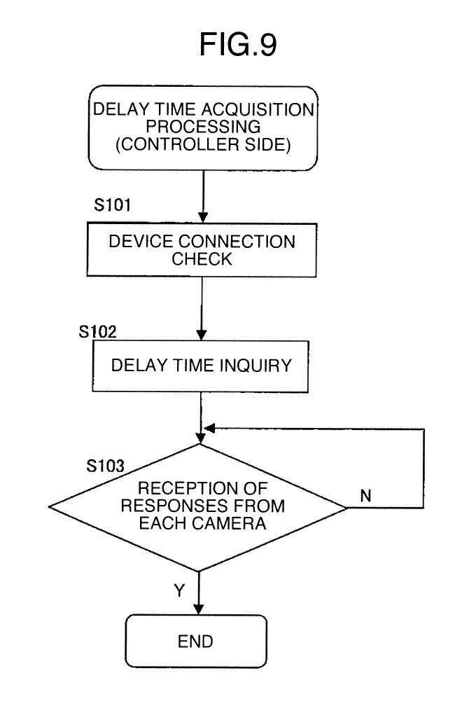

FIG. 9 is a flowchart of an acquisition process of delay times due to the controller. Controller 5 first checks cameras connected with LAN 4 (Step S101). This can e.g. be implemented by means of broadcast packets capable of transmitting packets to all devices connected with LAN 4. Also, it is acceptable to transmit check packets individually with respect to each of the cameras. Next, with respect to each of the cameras connected with LAN 4, enquiries are made about the processing delay times of the respective cameras (Step S102) and the processing delay time responses from each of the cameras are received (Step S103). In this way, controller 5 is able to acquire the processing delay times of the cameras connected with LAN 4. These processes are e.g. carried out at the time of power-up of controller 5.

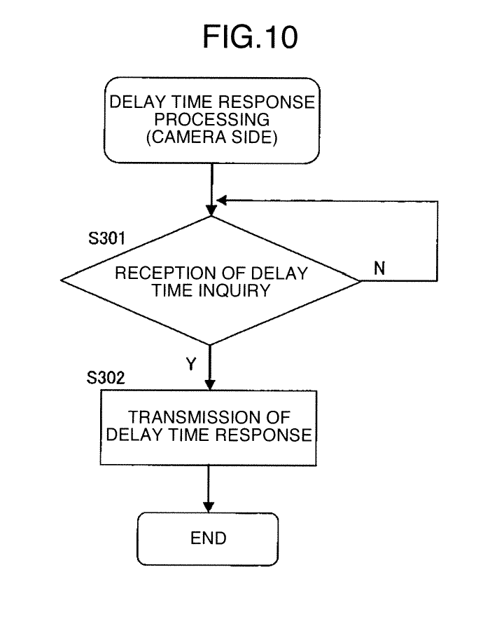

FIG. 10 is a flowchart of the delay time response process in the cameras, associated with the present embodiment. As mentioned above, in the case of receiving a delay time inquiry request from controller 5 (Step S301), the settable delay times of the same camera, e.g. the range from shortest settable delay time up to the longest settable one, are transmitted as a response to controller 5 (Step S302). In this way, it becomes possible for a camera connected with LAN 4 to communicate the processing delay times of the same camera to the controller. The camera computes the shortest delay time based on the compression method of the video images to be acquired and the video image bit rate before the request from controller 5, or in response to the request from controller 5, stores the computed shortest delay time in a (not illustrated) memory 109, reads out the shortest delay time from memory 109 in response to the request, and reports the same to controller 5, as stated above. In the case where the camera computes the shortest delay time in response to the request from controller 5, there is the effect that it is possible to compute the shortest delay time corresponding to the video compression method and the bit rate in the camera, at the point in time of the same request. In particular, this is effective in the case where it is possible for controller 5 to instruct the camera to make modifications in the compression method and the bit rate.

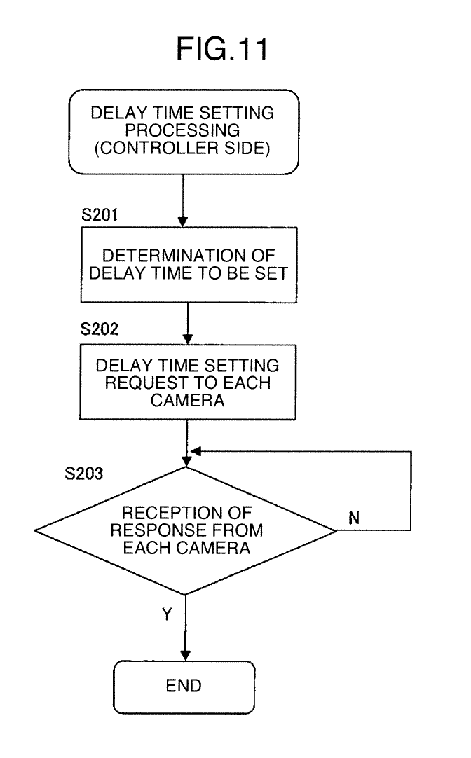

FIG. 11 is a flowchart of a delay time setting process due to the controller. First, the processing delay time to be set is decided (Step S201). Here, the longest time from among the shortest delay times of each of the cameras, acquired by means of the delay time acquisition process of FIG. 9, is taken to be the processing delay time to be set in each camera. However, it is taken to be a requirement that there is set, in the cameras, a processing delay time that is shorter than the shortest time from among the longest delay times of each of the cameras.

In case this requirement is not satisfied, controller 5 transmits a shortening request for the shortest delay time to the camera having transmitted a shortest delay time for which it is not satisfied and, also, transmits a lengthening request for the longest delay time to the camera having transmitted a longest delay time for which it is not satisfied. Due to the fact that the camera having received the shortening request for the shortest delay time e.g. modifies the compression processing method, it is possible to attempt a shortening of the shortest delay time. Controller 5 judges whether the shortest delay time and the longest delay time received from each of the cameras with respect to the aforementioned shortening request satisfy the aforementioned request. In case the requirement is still not satisfied, controller 5 outputs an error. In the case where the requirement has been satisfied, controller 5 takes the shortest delay time shortened by means of the aforementioned shortening request to be the processing delay time to be set in each of the cameras.

Next, controller 5 requests the setting of the decided processing delay time with respect to each of the cameras (Step S202) and receives setting result responses from each of the cameras (Step S203). In this way, the setting by controller 5 of the processing delay times for the cameras connected with LAN 4 becomes possible.

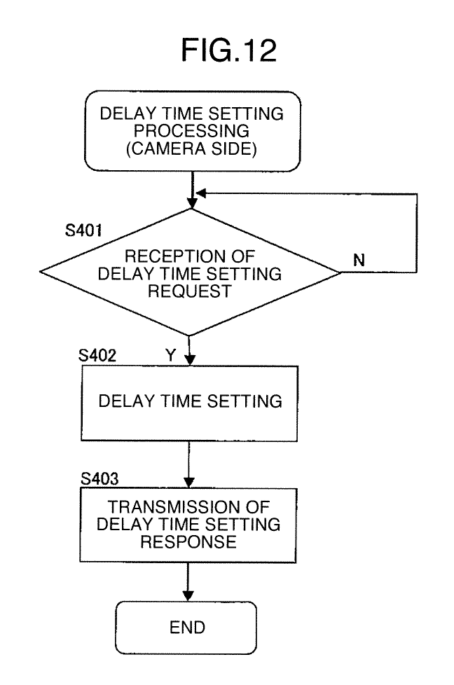

FIG. 12 is a flowchart of a delay time setting process in cameras, in the present embodiment. As mentioned above, in the case where a delay time setting request is received from controller 5 (Step S401), the camera sets the delay time (Step S402), and transmits the result thereof as a response to the controller (Step S403). In this way, it becomes possible for the cameras connected with LAN 4 to set the processing delay time in response to a request from the controller.

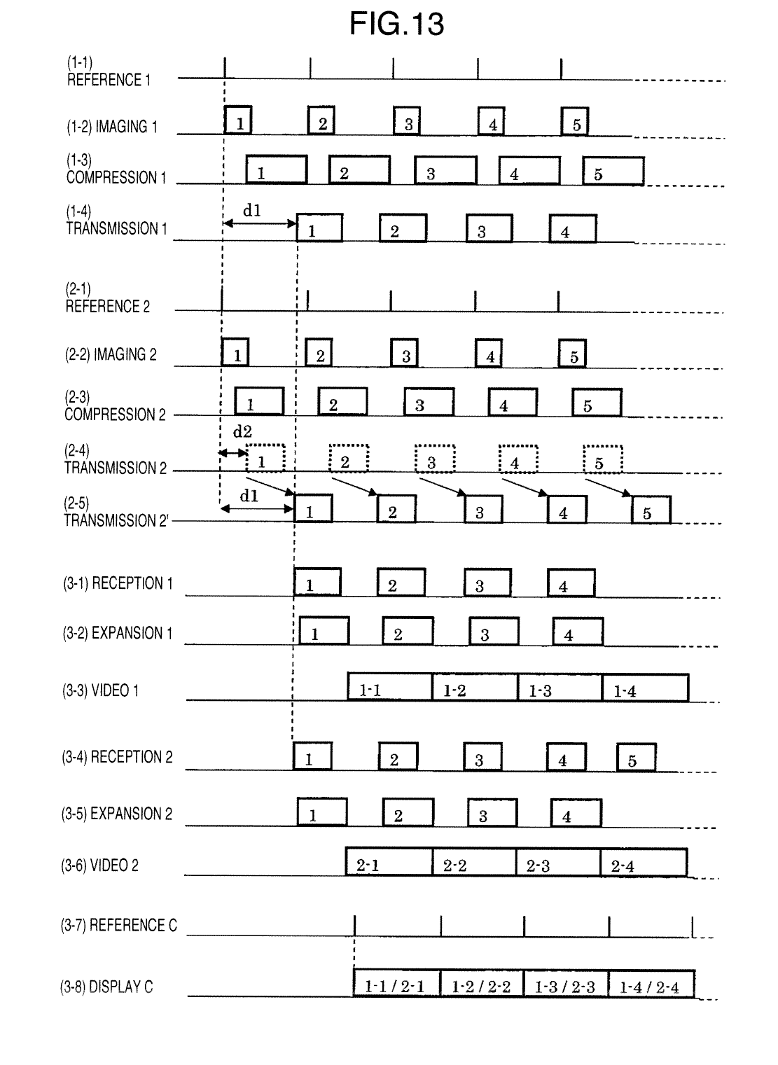

FIG. 13 is a diagram showing an example of transmission processing timings of each of the cameras and reception processing timings of controller 5, in the present embodiment.

In the same diagram, Refs. 1-1 to 1-4 indicate processing timings of camera 1, Refs. 2-1 to 2-5 indicate processing timings of camera 2, and Refs. 3-1 to 3-8 indicate processing timings of controller 5.

Ref. 1-1 designates a reference signal 1, Ref. 1-2 an imaging timing 1 at which imaging processing due to imaging element 101 is carried out, Ref. 1-3 a video compression timing 1 at which video compression processing due to video compression circuit 102 is carried out, and Ref. 1-4 a transmission timing 1 at which transmission processing due to LAN interface circuit 107 is carried out. Here, one frame's worth of video signal processing is carried out for each reference signal. Camera 1 starts imaging processing with e.g. the timing of the pulse of reference signal 1 and subsequently, video compression processing and transmission processing is progressively carried out in order. In camera 1, a time d1 from reference signal 1 up to the transmission processing start of transmission timing 1 becomes the processing delay time.

Also, Ref. 2-1 designates the reference signal of camera 2, Ref. 2-2 designates an imaging timing 2 at which imaging processing due to imaging element 101 of camera 2 is carried out, Ref. 2-3 designates a video compression timing 2 at which video compression processing due to video compression circuit 102 is carried out and Ref. 2-4 designates a transmission timing 2 at which transmission timing due to LAN interface circuit 107 is carried out in the case where the setting of a processing delay time is not carried out in camera 2. Camera 2, taking reference signal 2 to be a processing reference, starts imaging processing with the timing of reference signal 2 and thereafter progressively carries out video compression processing and transmission processing in regular order. In camera 2, the time d2 from reference signal 2 up to transmission timing 2 becomes the processing delay time. Also, as mentioned above, reference signal 1 of camera 1 and reference signal 2 of camera 2 are synchronized.

Here, controller 5 acquires, as mentioned above, the processing delay times of camera 1 and camera 2. Since, as a result of the acquisition, processing delay time of camera 1 is longer than processing delay time d2 of camera 2, controller 5 sets, with respect to camera 2, the processing delay time of camera 2 so that the processing delay time becomes d1. Ref. 2-5 designates a transmission timing 2′ after the processing delay time has been set. The adjustment of the processing delay time can here e.g. be implemented by adjusting the timing read out in order to input, into LAN interface circuit 107, the packet string from system encoder 104, shown in FIG. 2, which is stored in packet buffer 105. In this way, the result is that transmission timing 1 of camera 1 and transmission timing 2′ of camera 2 coincide.

Next, Ref. 3-1 designates a reception timing 1 at which controller 5 carries out reception processing of LAN packets from camera 1, Ref. 3-2 designates a video expansion timing 1 at which video expansion processing due to video expansion circuit 5031 is carried out, and Ref. 3-3 designates a camera 1 video output timing 1 for one frame expanded and acquired by video expansion circuit 5031. Also, Ref. 3-4 designates a reception timing 2 at which controller 5 carries out reception processing of LAN packets from camera 2, Ref. 3-5 designates a video expansion timing 2 at which video expansion processing by video expansion circuit 5032 is carried out, and Ref. 3-6 designates a camera 2 video output timing 2 for one frame expanded and acquired by video expansion circuit 5032. Further, Ref. 3-7 designates a reference signal C in controller 5 and Ref. 3-8 designates a display timing C of displayed video images that controller 5 outputs to display 6.

Controller 5 takes reception timing 1 from camera 1 to be a processing reference and progressively carries out video expansion processing straight after the reception processing, in regular order. Similarly, it carries out video expansion processing straight after reception processing from camera 2. Here, since transmission timing 1 of camera 1 and transmission timing 2′ of camera 2 coincide, video output timing 1 and video output timing 2 coincide. E.g., reference signal C is generated by adjusting to video output timings 1 and 2, so by carrying out display processing with the timing of the pulse of reference signal C, it becomes e.g. possible to combine video images of camera 1 and video images of camera 2 and display, on display 6, combined video images with a display timing C.

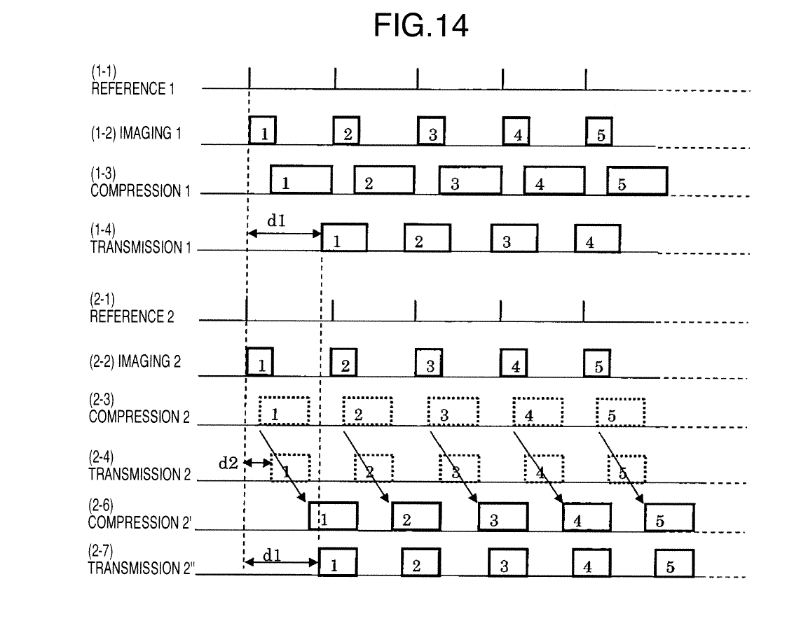

FIG. 14 is a diagram showing another example of reception processing timing of each of the cameras in the present embodiment. Controller 5 sets, with respect to camera 2, the processing delay time of camera 2 so that the processing delay time becomes d1, and in this example, camera 2 adjusts the timing of starting video compression processing so that the processing delay time becomes d1. This processing delay time adjustment can e.g. be implemented by adjusting the timing at which video data stored in the video buffer from video compression circuit 102 shown in FIG. 2 are read out by video compression circuit 102 for the purpose of video compression processing. Ref. 2-6 designates a video compression timing 2′ after the processing delay time has been set and Ref. 2-7 designates a transmission timing 2″ accompanying the same. The result is that in this way, transmission timing 1 of camera 1 and transmission timing 2″ of camera 2 coincide. Consequently, similarly to FIG. 13, it becomes possible to combine video images of camera 1 and video images of camera 2 and display combined video images on display 6 with a display timing C.

In the aforementioned description, the delay time of the processing time was defined to be that from a reference signal being a starting point up to a transmission start time being an ending point, but the embodiment is not limited hereto, it being acceptable, e.g., to take the starting point to be the time at which imaging element 101 starts imaging and take the ending point to be the transmission ending time of the transmission timing of each of the frames.

Also, it is possible to adapt the video output timing of each of the cameras by adding the difference in video expansion processing times due e.g. to the difference in compression method or the difference in bit rate for each of the cameras, to the set processing time corresponding to the camera. In this case, by controller 5's measuring the video expansion processing time for each camera, transmitting, as the processing delay time to each of the cameras, a time with the difference from the longest video expansion processing time added as an additional processing extension time to the processing delay time of the camera, and giving an instruction for the setting of a new processing delay time to each of the cameras, it is possible to make the video output timing (3-3, 3-6, etc.) in controller 5 of each of the cameras coincide more accurately.

In addition, there was shown an example of implementing the acquisition of the processing delay time of each of the cameras by means of an inquiry from controller 5, but it is also acceptable to make a report from the side of each of the cameras to controller 5, e.g. at the time of power-up of the cameras or at the time at which the same are connected with LAN 4.

Also, in the aforementioned description, a description was given regarding the transmission and reception of video signals, but, similarly, communication of audio signals is also possible.

As mentioned above, by adjusting the delay time associated with each of the cameras, it becomes possible to display video images for which the display timings coincide.

In addition, since it is not necessary for controller 5 to perform processing to absorb display timing misalignment in the video images from each of the cameras, it becomes possible to display video images with display timings that coincide, without the processing becoming complex.

### Embodiment 2

Next, a description will be given regarding a separate video communication system embodiment including cameras being video communication devices. Regarding portions that are the same as Embodiment 1, a description thereof will be omitted.

In Embodiment 1, as shown in FIG. 13 and FIG. 14, there was described an example in which camera reference signal 1 and reference signal 2 are synchronized, including both the period and the phase. However, in reality, there are also cases where the phases of a system in which only the period (or the frequency) of the reference signal coincides between systems do not necessarily coincide. In the present embodiment, such a case is assumed, and there is carried out a description regarding the case in which the period of reference signal 1 and reference signal 2 coincide, but the phases thereof do not coincide.

In the present embodiment, there is provided a mechanism to synchronize time between each of the cameras and the controller. As a method of synchronizing time, it is e.g. possible to use the method mentioned in the IEEE 1588 Standard. Time is synchronized between systems at regular intervals using such a method and, using the same time, the oscillation period of a reference signal inside the system is adjusted using e.g. PLL (Phase Locked Loop). By proceeding in this way, it is possible to make the reference signal periods coincide between systems.

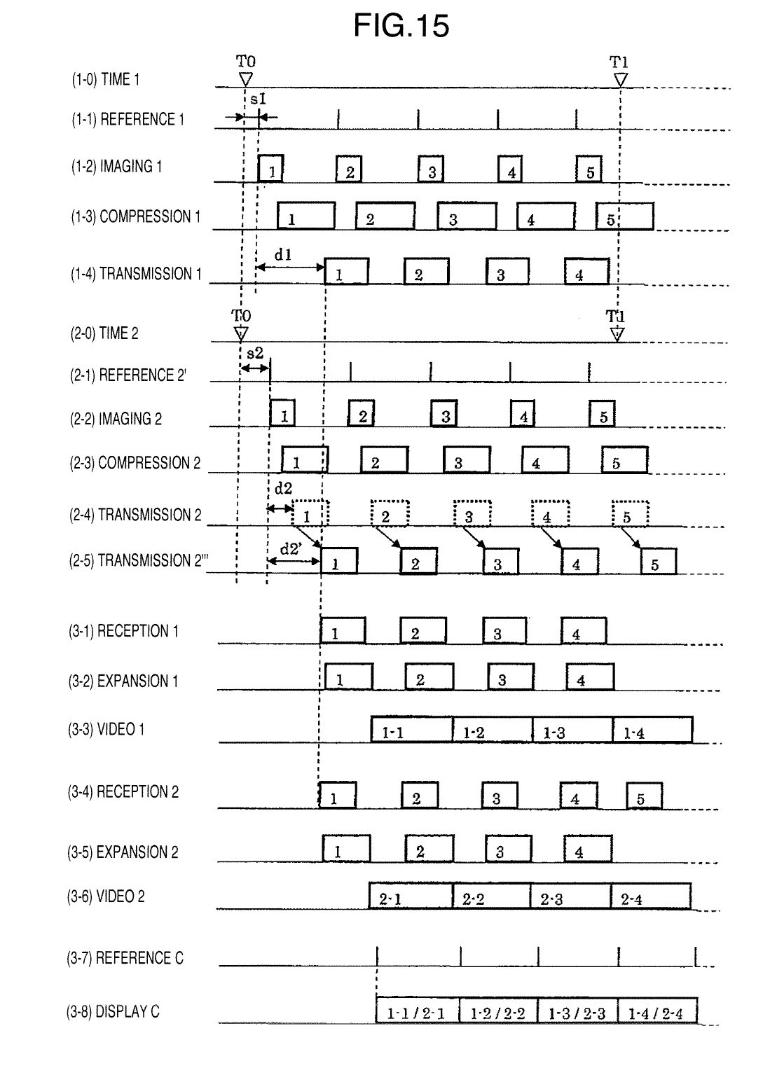

FIG. 15 is a diagram showing an example of the transmission processing timing of each of the cameras associated with the present embodiment. Refs. 1-0 and 2-0 respectively indicate the reference times (internal clocks) of camera 1 and camera 2. By attaining synchronization at regular intervals (e.g. at T0 and T1) by means of the aforementioned method, these are mutually made to coincide.

In camera 1, reference signal 1 (1-1) is generated by oscillation in the interior. On that occasion, the oscillation period is adjusted based on reference time 1 (1-0). Similarly, reference signal 2′ (2-1) is generated by oscillation in the interior, in camera 2. On that occasion, the oscillation period is adjusted based on reference time 2 (2-0).

In this way, since each of the cameras regulates the oscillation period of the reference signal based on the respective reference time, the periods of reference signal 1 and reference signal 2″ coincide. However, the mutual phases do not necessarily coincide.

The time from reference time T0 up to reference signal 1 is taken to be s1. When camera 1 reports the processing delay time to controller 5 (Step S103 in FIG. 9), it reports S1 and d1. Similarly, the time from reference time T0 up to reference signal 2 is taken to be s2 and camera 2 reports s2 and d2 to controller 5. As for d1 and d2, the range may be taken to be from the shortest delay time and up to the longest settable time, similarly to Embodiment 1.

As for each of the cameras, it is possible to measure s1 and s2 by taking e.g. the time of compensating the reference time as the starting point and looking up the reference time at the time when reference signal generation circuit 106 generated the reference signal. Alternatively, by also providing a counter in a separate camera, making the counter start counting at the time of compensating the reference time, and measuring, with the counter, the time until reference signal generation circuit 106 generates the reference signal, it is possible to measure s1 and s2. When controller 5 determines the delay time to be set (Step S201 in FIG. 10), it makes the determination bearing in mind the phase difference of reference signal 1 and reference signal 2. E.g., in FIG. 15, since in this case, when considering time T0 to be the reference, s1+d1 is longer than s2+d2, d2′ is set for camera 2 to be d2′=s1+d1−s2 so that the total delay time becomes s1+d1=s2+d2′.

Ref. 2-5 designates a transmission timing 2′″ after the processing delay time has been set. In this way, the result is that transmission timing 1 of camera 1 and transmission timing 2′″ of camera 2 coincide.

Further, in the aforementioned embodiment, when camera 1 reports the processing delay time to controller 5, an example in which s1 and d1 were reported was shown, but it is also acceptable to report instead only the total times D1=s1+d1 (D2=s2+d2 in the case of camera 2) thereof. In that case, controller 5 sets D2′=D1 with respect to camera 2 so that total time D2 becomes equal to D1. Even if proceeding in this way, it is possible to obtain the same effect.

Even if each of the cameras, similarly to Embodiment 1, reports the delay time to controller 5, e.g. at start time, the delay time may also be reported to controller 5 in response to a request from controller 5. In the latter case, the camera can report the difference in time at that point in time between the reference time and the reference signal to controller 5. Also, in the case where it is possible to modify the camera video compression method or bit rate by means of an instruction from controller 5, the camera can report to controller 5 the delay time at that point in time, reflecting the camera processing delay time to be changed as a result of the modification in the video compression method or the bit rate. Because of this, controller 5 can compute the processing delay time to be set in the camera, reflecting the time difference between the reference time and the reference signal in each camera or the video compression method or the bit rate, so at the point in time of the same request, there can be expected an improvement in the synchronization accuracy of the video output timing of each camera in controller 5.

Further, the processing to synchronize the times in each of the cameras may be carried out inside control circuit 108 of FIG. 2, or may be carried out by providing, separately from control circuit 108, a dedicated circuit for carrying out time synchronization. In the latter case, by concentrating the concerned dedicated circuit on time synchronization processing, it can be expected that the accuracy of the synchronization is increased.

### Embodiment 3

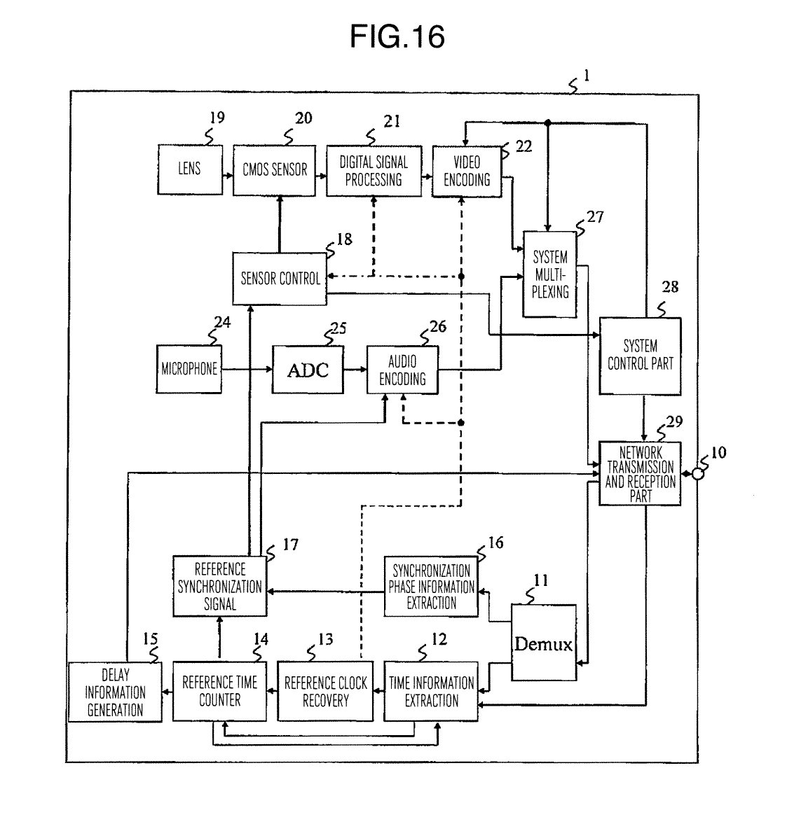

In FIG. 16, there is shown a block diagram of Embodiment 3 of the present invention. Hereinafter, Embodiment 3 will be described using the present diagram.

The present embodiment is a network camera that video encodes 1920×1080 pixel video images captured with 30 frames per second in compliance with the H.264/AVC (ISO/IEC 14496-10) Standard and, in addition, performs MPEG-1 Layer II audio encoding processing of 12-bit audio data captured with a sampling rate of 48 KHz and packet multiplexes the same. In the network, it is assumed that there is e.g. used a method defined in the IEEE 802.3 Standard which is a data link protocol. Further, in the present embodiment, it is assumed that there will be performed previously existing PCM (Pulse Code Modulation) sampling and carried out encoding transmission based on MPEG-1 Layer II, a limitation being made to only illustrating the block structure in the drawing.

In a network transmission and reception part 29 of FIG. 16, there is, after system start, carried out a communication link, according to a protocol compliant with the IEEE 802.3 Standard, with a receiver connected with a not illustrated network that is linked with a terminal 10. IEEE 802.3 input packet strings are received as LAN packets compliant with e.g. the IEEE 802.3 Standard. A method according to PTP (Precision Time Protocol) described in the standard IEEE 1588: IEEE 1588-2002 “Precision Clock Synchronization Protocol for Networked Measurement and Control Systems” is also acceptable. In the present embodiment, the description regarding the time synchronization system is given assuming a simplified protocol.

In the present system, the receiver side is defined to be the server for time synchronization and the transmitter side is defined to be the client side that adapts to the time of the server side.

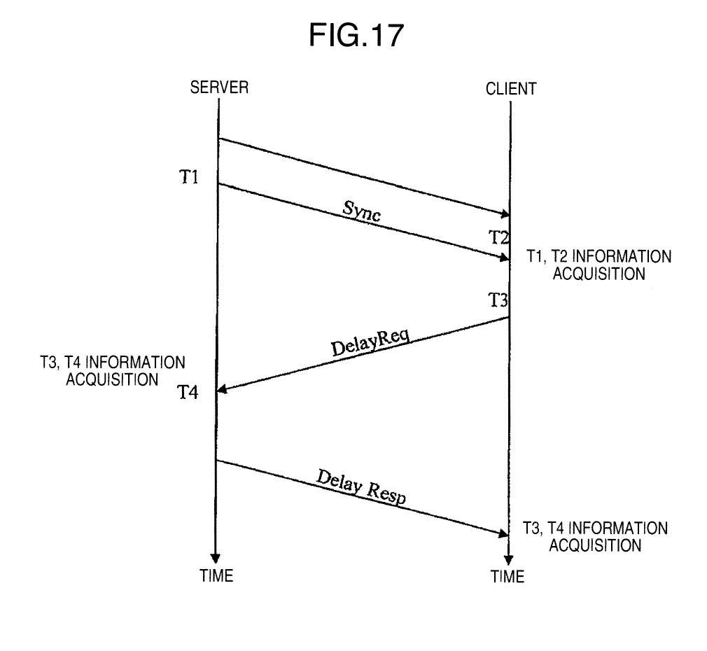

In FIG. 17, there is shown a packet transmission and reception method carried out in order for the server side and the client side to attain synchronization.

The server side transmits an initial packet for obtaining synchronization information at the T1 time point, in order to attain synchronization. The present packet is called a “Sync packet” and network transmission and reception part 29 in FIG. 16, having received this packet, transmits the packet to a packet separation part 11. Further, packet separation part 11 distinguishes from an identifier that it is a Sync packet and sends it to a later-stage time information extraction part 12. In time information extraction part 12, the server side packet transmission time (T1), recorded in the packet, and the time (T2) at which the packet arrived at time information extraction part 12 are obtained from a reference time counter 14 inside the transmitter. The reference time counter, as will be subsequently mentioned, increments the reference time using a system clock generated in a reference clock recovery 13. Next, in delay information generation part 15, a packet (DelayReq) to be sent from the client to the server is generated and sent to network transmission and reception part 29. In network transmission and reception part 29, a timing (T3) at which the present packet will be transmitted is read from the reference time counter and transmitted to the receiver (server). At the same time, the information about T3 is transferred to time information extraction part 12. In the server, the timing (T4) at which the DelayReq packet arrived is read and this is recorded inside a DelayResp packet and transmitted to the client side. The DelayResp packet, having arrived at the transmitter (client) side, is transmitted to packet separation part 11 and is, after a confirmation that it is a DelayResp packet, transmitted to time information extraction part 12. In time information extraction part 12, the T4 information recorded inside the DelayResp packet is extracted. With the aforementioned process, it becomes possible for time information extraction part 12 to obtain time information about T1, T2, T3, and T4.

Since the time differences between the server and the client at the time of packet transmission and reception become, if the network communication delay Tnet and the reference time difference Toffset (client time−server time) of the two devices are considered, T2−T1=Tnet+Toffset and T4−T3=Tnet−Toffset (note, however, that the network communication delays between the server and the client are assumed to be the same times in the uplink and the downlink), it is possible to obtain the same as Tnet=(T2−T1+T4−T3)/2 and Toffset=T2 −T1−Tnet.

Time information extraction part 12 computes Toffset by means of the aforementioned calculation, at a stage when T1, T2, T3, and T4 information has been obtained. Further, time information extraction part 12 performs control so as to return reference time counter 14 from the current time by the Toffset portion.

In the same way as above, the transmission and reception of Sync, DelayReq, and DelayResp packets is repeated several times, Toffset is calculated over several times, and control information is sent to reference clock recovery part 13 in the direction in which Toffset approaches 0. Specifically, reference clock recovery part 13 is e.g. configured with a VCXO (Voltage Controlled Crystal Oscillator), so in the case where Toffset takes on a positive value and it is desired to slow down the clock, the voltage supplied to reference clock recovery part 13 is lowered and, on the contrary, in the case where Toffset takes on a negative value and it is desired to speed up the clock, the voltage supplied to reference clock recovery part 13 is raised.

As for this control, it is possible, by providing feedback control modifying the voltage control range in response to the absolute value of Toffset, to stabilize the clock sent out from reference clock recovery part 13 to reference time counter 14 and make it converge with the frequency synchronized on the server side. Also, it becomes possible to synchronize the transmitter side with the receiver side and update reference time counter 14.

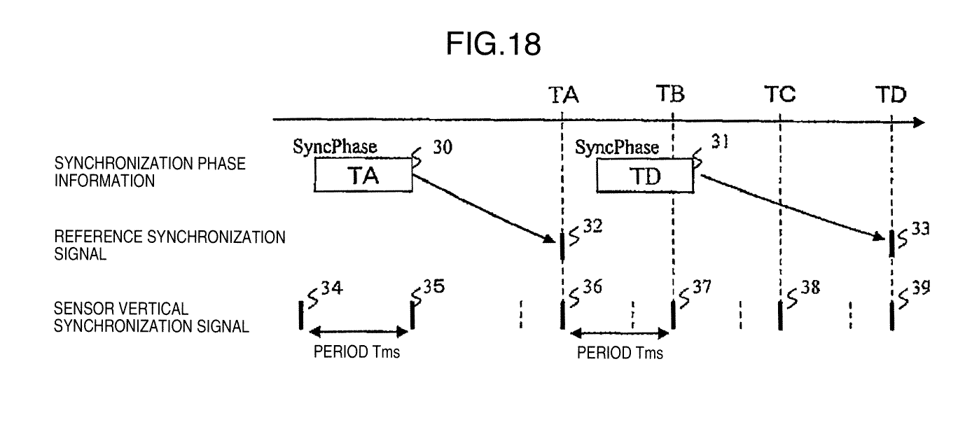

From among the packets received from the receiver side, network transmission and reception part 29 also transmits, in addition to the packets for attaining synchronization, packets in which synchronization phase information is included to packet separation part 11. In packet separation part 11, regarding packets in which synchronization phase information is included, the same are sent to a synchronization phase information extraction part 16. In the present packets, the timing of the operating synchronization signal of the transmitter is pointed out taking reference time counter 14 to be a reference. E.g., as shown in FIG. 18, network transmission and reception part 29 receives a packet 30 (below indicated as SyncPhase) in which received synchronization phase information is included and sends it to synchronization phase information extraction part 16.

In synchronization phase information extraction part 16, reference synchronization signal generation timing TA, recorded inside SyncPhase, is extracted. TA is a timing indicating the reference time counter value that should generate a reference synchronization signal on the transmitter side.

The storage location inside the packet is specified on the transmission and reception sides, so if one analyzes the data based on the same syntax, the storage location of the TA information is uniquely identified and it is possible to extract the data. The extracted timing TA is transferred to a reference synchronization signal generator 17.

Reference synchronization signal generator 17, as shown in FIG. 18, looks up the reference time sent from reference time counter 14, generates a reference synchronization signal 32 at the point in time when the TA timing has been reached, and sends the same to a sensor control part 18. Similarly, each time one of the following packets, from SyncPhase 31 and onward, arrives, a reference synchronization signal 33 is generated whenever required. Sensor control part 18, having received the reference synchronization signal, modifies the sensor vertical synchronization signal generation timing of the sensor vertical synchronization signal generated so far in free-run operation with a period Tms, such as Refs. 34 and 35 in FIG. 18, to the timing of reference synchronization signal timing 32.

Thereafter as well, the period Tms is counted based on the reference clock received from reference clock recovery 13 and for each period Tms, a sensor vertical synchronization signal is generated (Refs. 36 to 39 in FIG. 18). Also, regarding synchronization signals from reference synchronization signal 33 and onward, since the same have a timing that is identical to that of vertical synchronization signals generated in sensor control part 18, signal generation is continued as is for each period Tms as long as no phase shift is detected.

At subsequent reference synchronization signal arrival times, if it is checked either once or several times that the phases with respect to the sensor vertical synchronization generated in sensor control part 18 are either equal or within a certain time range, it is considered that the assumed synchronization signals on the receiver side and the transmitter side have aligned and a phase regulation check completing signal is transmitted to a system control part 28.

In the case where there is found misalignment between the phase between the reference synchronization signal and the vertical synchronization signal (e.g. Refs. 33 and 39), it is considered that the timing of the synchronization signals have changed due to an anomaly on the receiver side and there is carried out a phase misalignment report to system control part 28. As mentioned above, if the transmission interval timings of the information for phase regulation (SyncPhase) is relatively longer than the generation period Tms of the vertical synchronization signal, it becomes possible, as for the vertical synchronization signal generated in sensor control part 18, to generate the vertical synchronization signal highly accurately based on the reference clock and the reference time, at the stage where phase regulation has once been carried out. When it comes to this point, the present method is also effective for a reduction in network traffic due to transmission.

Also, by means of SyncPhase which is transmitted at regular intervals, it is possible to detect that the phase of the synchronization signals is misaligned due to some kind of system anomaly and it becomes possible to carry out control of subsequent error correction.

In system control part 28, after a phase regulation check completion signal has been received, a lens part 19, a CMOS (Complementary Metal Oxide Semiconductor) sensor 20, a digital signal processing part 21, a video encoding part 22, and a system multiplexing part are controlled and video encoding is started. Regarding the video encoding, there is carried out common video imaging and digital compression encoding. E.g., lens part 19 carries out lens part movements for the purpose of AF (autofocus) received from system control part 28 and CMOS sensor 20, after receiving light from the lens part and amplifying the output values, outputs the same as digital video images to digital signal processing part 21. Digital signal processing part 21 conducts digital signal processing from e.g. Bayer array shaped RAW data received from CMOS sensor 20 and, after converting the same into brightness and color difference signals (YUV signals), transfers the same to video encoding part 22.

In the video encoding part, encoding processing is performed progressively, handling image clusters captured within respective vertical synchronization intervals as units consolidated as pictures. At this point, there are e.g. generated either I pictures (Intra pictures) using prediction within intra frames or P pictures (Predictive pictures), using only forward prediction, so that the encoding delay time does not become several frame intervals. On this occasion, video encoding part 22 adjusts the encoded amount of bits after encoding each MB (Macro Block) consisting of 16 pixels (width)×16 pixels (height) so that the generated amount of bits approaches a fixed bit rate. In concrete terms, it becomes possible, by adjusting the quantization step, to control the generated amount of bits for each MB. Until the processing of several MBs comes to an end, the bit stream is stored in the system multiplexing part, in the internal buffer and at a stage when a prescribed number of MBs have been stored, the bit stream is converted into TS packets, having a fixed length of 188 bytes, in the system multiplexing part and output as an MPEG-2 TS (Transport Stream) stream. Further, in network transmission and reception part 59, the stream is converted into MAC (Media Access Control) packets and transmitted to the receiver side via the network.

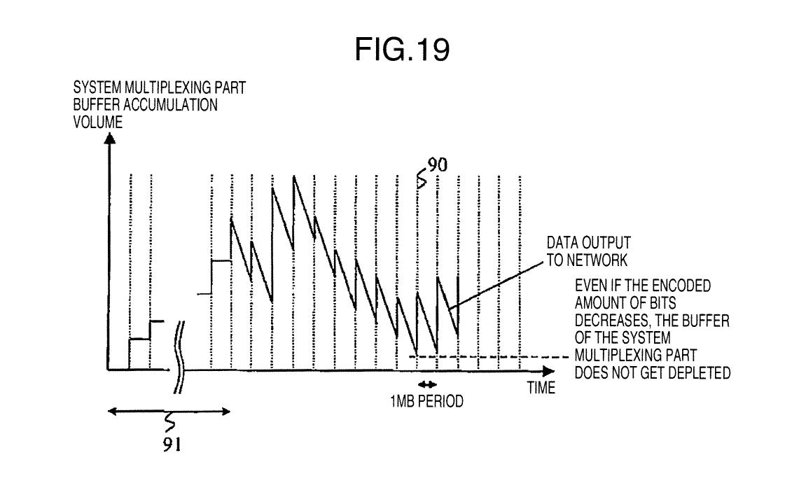

FIG. 19 is a diagram exemplifying transition states of the stream accumulation volume of the internal buffer in the system multiplexing part. In the present diagram, for the sake of convenience, the system is taken to be one in which the code encoding each MB is, for each MB interval, momentarily accumulated in the buffer and the stream is output to the network with a fixed throughput for each MB interval.

The output start timing of the stream associated with the aforementioned system multiplexing part is controlled only by waiting for a prescribed standby time during which the buffer of the system multiplexing part does not get depleted (timing 91 in FIG. 19), even in the case where the generated amount of bits (throughput) of the bit stream varies when outputting to the outside with a fixed bit rate and the encoded data stored inside the buffer of the system multiplexing part have become the least (timing 90 in FIG. 19). Generally, by modifying the aforementioned quantization step in response to buffer transitions while monitoring the actual encoded amount of bits, these controls become possible to control the encoded amount of bits within a prescribed number of MB intervals and restrain the output to a fixed jitter range with respect to the output bit rate. By providing only the time portion required for this convergence, an interval corresponding to standby time 91 in FIG. 19, it is possible to implement a system in which the buffer of the system multiplexing part does not get depleted.

By defining the present time interval as the transmitter side specification, it becomes possible to calculate the subsequent communication delay on the receiver side.

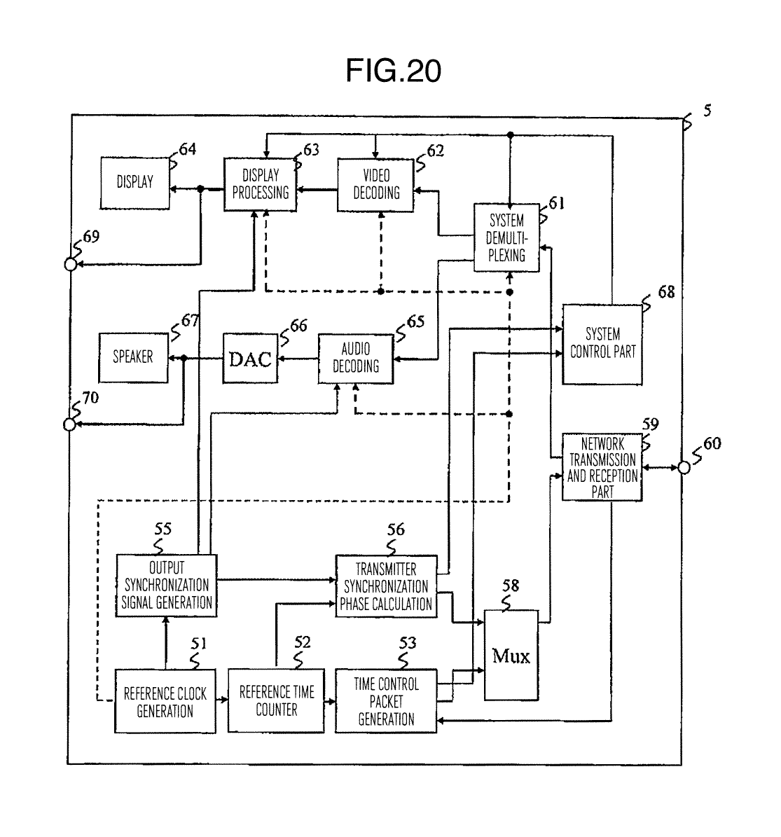

Next, using FIG. 20, the block structure and operation of the receiver side will be described. In a reference clock generation part 51, the reference clock on the receiver side is generated. The present reference clock becomes a reference clock for attaining time synchronization on the server side and the client side shown in FIG. 17, the clock being generated in Ref. 51 by means of free-run operation without using other external synchronization such as a quartz crystal oscillator.

The present clock counts the reference time on the server side in a reference time counter 52 as a reference. In a time control packet generation part 53, there is carried out generation of a (Sync) packet for the purpose of time synchronization, shown in FIG. 17, using the present reference time. Time T1 recorded inside the packet at the time of Sync transmission is generated with the present clock. The generated (Sync) packet is multiplexed with other packets in a packet multiplexing part 58, is further modulated in a network transmission and reception part 59, and is communicated to a transmission part via a network connected with the outside from a network terminal 60. Besides, at the time of receiving a SyncReq packet received from the transmission part, a reception timing report from network transmission and reception part 59 is received and the reference time (T4 in FIG. 17) is recorded in time control packet generation part 53. By the use of the present T4, a DelayResp packet is generated in time control packet generation part 53 and is transmitted to the transmitter side via packet multiplexing part 58 and network transmission and reception part 59.

Next, a description will be given regarding the generation of vertical synchronization timing on the receiver side. Taking as a reference the reference clock generated in reference clock generation part 51, a vertical synchronization signal at the time of output is generated in an output synchronization signal generation part 55. The present vertical synchronization signal is sent to a transmitter synchronization phase calculation part 56. Here, as will be subsequently described, the phase of the vertical synchronization signal on the transmitter side is calculated from the vertical synchronization signal phase at the time of output on the receiver side and, using counter information in the reference time counter, the SyncPhase packet shown in FIG. 18 is generated. The SyncPhase packet is transmitted to the packet multiplexing part and is, similarly to the Sync packet, transmitted to the transmitter side from network transmission and reception part 59 and network terminal 60.

Next, a description will be given regarding the video decoding procedure in the receiver. A MAC packet including an MPEG-2 TS stream related to received video images is transferred by network transmission and reception part 59 to a system demultiplexing part 61. In system demultiplexing part 61, TS packet separation and video stream extraction are carried out. Regarding the extracted video stream, it is sent to a video decoding part 62. Regarding the audio stream, it is sent to an audio decoding part 65 and output to speakers after applying a digital-to-audio conversion in a DA converter 66.

In system demultiplexing part 61, after accumulating the stream in an internal buffer for a prescribed standby time only, the stream is output to video decoding part 62 and decoding is started.

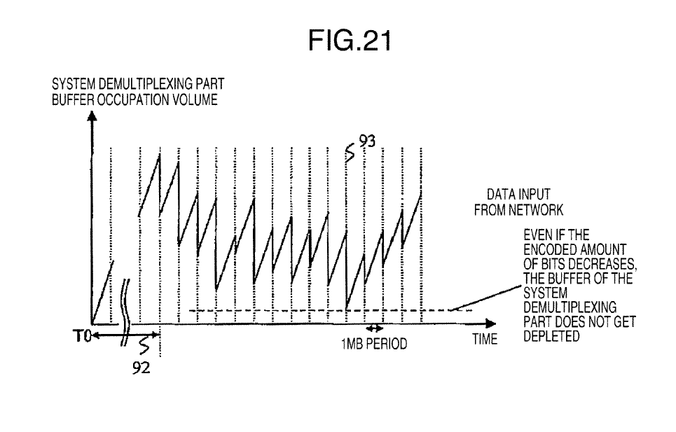

In FIG. 21, there is shown an example of transition states at the time on the occasion that a stream is accumulated in the internal buffer in system demultiplexing part 61. In the present diagram, for the sake of convenience, there is shown modeling that the stream is supplied from the network at a fixed bit rate and that, for each MB unit time, a stream corresponding to each MB is instantaneously output in video decoding part 62.

From the stage of time T0, the input of the stream is started and after a standby for only the interval shown in interval 92, decoding of the stream is started. This is effected in that, even when the stream storage volume has become the least, as shown in timing 93, there is provided a standby time for devising the system so that it does not underflow. It is possible to implement this standby time by specifying, in the case where the minimum convergence time required in order for the transmitter side to make the generated amount of bits converge to the communication bit rate of the network is known, a time that is equal to or longer than the same time as the standby time.

The video stream read out from demultiplexing part 61 is decoded in video decoding part 62 and decoded images are generated. The generated decoded images are transferred to a display processing part 63, transmitted to a display 64 with a timing that is synchronized with a vertical synchronization signal, and displayed as motion video. Also, in order to transmit to e.g. external equipment, not illustrated, for image checking, the images are output from external terminal 69 as a video signal.

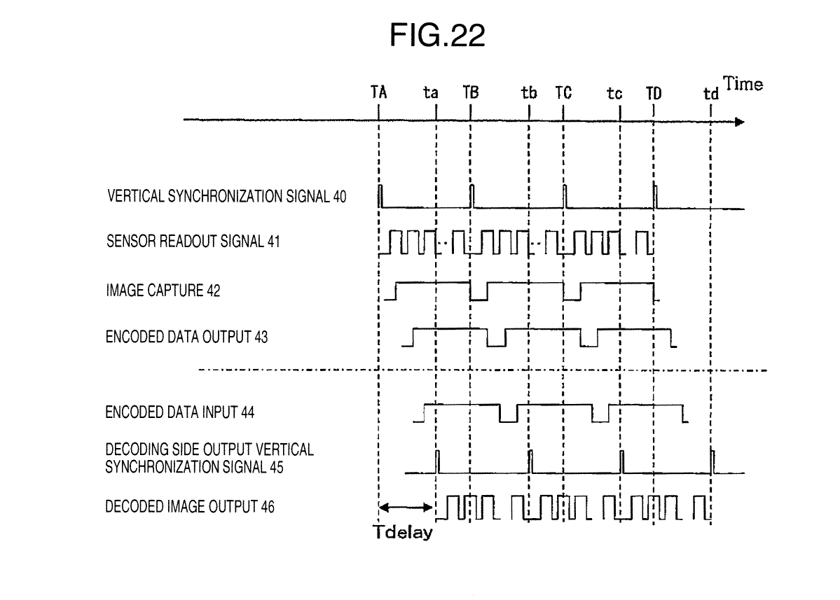

FIG. 22 is a diagram showing the relationship between control timings associated with each functional block of the receiver from the transmitter.

A vertical synchronization signal 40 in FIG. 22 indicates the vertical synchronization signal generated by sensor control part 18 in FIG. 16; a sensor readout signal 41 in FIG. 22 indicates the timing at which data are read out from the CMOS sensor in FIG. 16; image capture 42 in FIG. 22 indicates the video input timing to video encoding part 22 in FIG. 16; encoded data output 43 in FIG. 22 indicates the timing at which a video encoded stream is output from video encoding part 22 in FIG. 16; encoded data input 44 in FIG. 22 indicates the timing at which encoded data are input into video decoding part 62 in FIG. 20; an output vertical synchronization signal on the decoding side in FIG. 22 indicates the vertical synchronization signal output from display processing part 63 in FIG. 20 to either the display or external terminal 69; and, further, decoded image output 46 in FIG. 22 indicates the effective pixel interval of images output from display processing part 63 in FIG. 20 to either the display or external terminal 69. For the sake of convenience, the vertical blanking interval from vertical synchronization timing 40 up to sensor readout timing 41 is considered to be the same as the vertical blanking interval from the output vertical synchronization signal on the decoding side up to decoding image output 46.

Here, there is assumed a case in which it is possible to designate, by means of a design specification or the like, a delay time (Tdelay in FIG. 22) from the image output start (start time 41 of each frame in FIG. 22) of the CMOS sensor (Ref 20 in FIG. 16) on the transmitter side and up to the time (Ref 46 in FIG. 22) of receiving a packet received by the receiver side and outputting the same to either a display or another piece of equipment. The time Tdelay can be defined by adding up the delay time from the video image capture on the transmitter side and until transmitting a packet through encoding processing, the transfer delay of the network, and the delay time taken to be necessary from packet capture on the receiver side and up to output through decoding processing.

In transmitter synchronization phase calculation part 56 in FIG. 20, the reference times of the output timings (ta, tb, tc, . . . ) of output vertical synchronization signal 45 on the receiver side are calculated. This can be calculated by looking up the reference times of the output vertical sync signal of a certain sample and progressively incrementing the reference time counter corresponding to frame periods Tms. After calculating ta, tb, and tc, the times preceding the same by Tdelay (TA, TB, TC, . . . ) are calculated. E.g., it works out to TA=ta−Tdelay.

Times TA, TB, and TC calculated in this way are transmitted to the transmitter by means of SyncPhase, as shown in FIG. 18.

At this point, the times at which SyncPhase packets storing time information about TA, TB, and TC arrive on the transmitter side are respectively transmitted to the transmitter adding the network delay time Tnet so as to arrive sufficiently ahead of TA, TB, and TC.

Specifically, in the case where the receiver side adjusts the phase of the transmitter side synchronization signal in the SyncPhase packet at a time Tx, if the transmitting timing is taken to be Tsp and further, the time needed to analyze the information inside SyncPhase after the transmitter side has received SyncPhase is taken to be Ty, implementation is possible by selecting Tx so that there results that Tsp+Tnet+Ty<Tx or greater and generating SyncPhase packets. Further, as for each interval specifying the aforementioned control timings, such as Tdelay, Tnet, and Ty, it is possible, when jitter occurs in the same interval due to processing load and the like, to carry out the same control by taking into account carrying the worst value of the concerned interval.

According to the present system, it becomes possible to adjust the phase difference of vertical synchronization signals on the transmitter side and the receiver side to be equal to, or in a direction approaching, the delay time Tdelay taken to be necessary from video capture up to output. As mentioned above, the ability to specify Tdelay depends on having a means of obtaining the communication delay of the network and, further, on having fixed the encoding delay of the transmitter, the decoding delay of the receiver, and the buffer storage time to prescribed times. If it is the case that, without carrying out control such as in the present embodiment, what is concerned is a relationship such that TA+Tdelay>ta, it becomes impossible to output the video images captured between TA and TB in the frame interval starting from ta on the receiver side, so there is a need to delay the output timing until tb. Because of this, even in the case where Tdelay is sufficiently small compared to the vertical synchronization interval, the time from the imaging timing up to video output ends up becoming unnecessarily long. According to the present embodiment, it is possible to avoid a situation such as this and bring the total delay time closer to a delay time that is possible to implement with the delay time necessary for the communication capacity of the network as well as the encoding and decoding of the transmitter and the receiver.

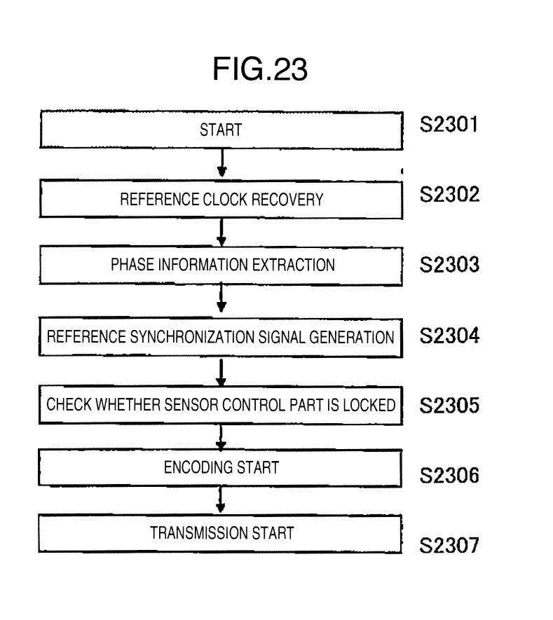

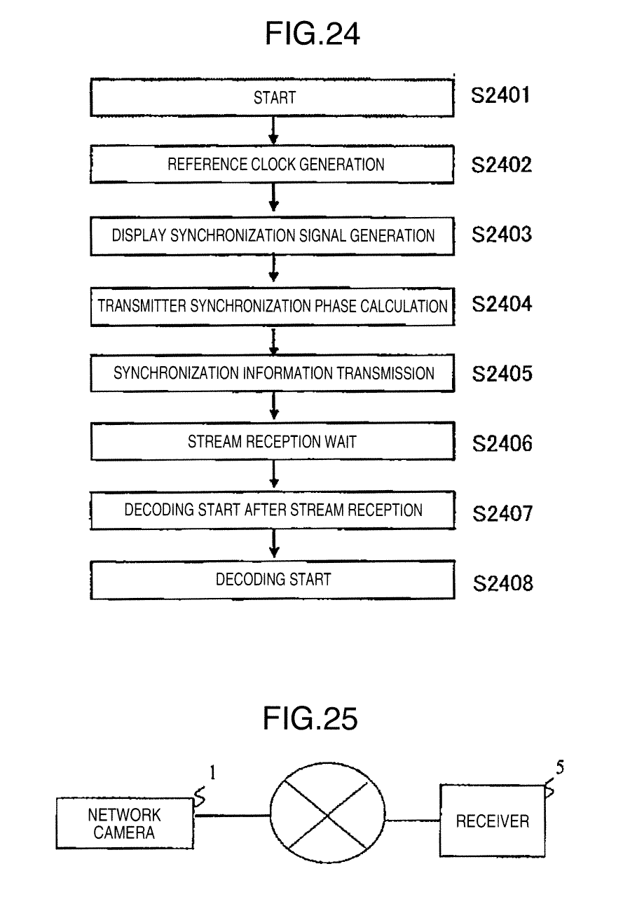

The procedures, described in the aforementioned embodiment, related to the clock synchronization, time synchronization, phase adjustment of the reference synchronization signal, and the transmission of an encoded stream are respectively shown in FIG. 23 and FIG. 24 regarding the transmitter and the receiver. By going through a series of these control steps, it is possible to construct a network camera system enabling a reduction in the delay of the time from imaging up to video output.

In FIG. 25, there is shown a system in which a network camera part 1 using a transmitter described in the present embodiment and a receiver 5 are connected with a network. By configuring a network camera system such as above, it is possible to construct a video transfer system reducing the total delay from imaging in the transmitter up to video output on the receiver side while ensuring a delay time capable of continuing to send video information without the system failing.

Also, the phase (time difference of the most recent launches of the two) of the synchronization signal for imaging on the transmitter side with respect to the timing of the synchronization signal for outputting video images by the receiver becomes fixed on each occasion of system launch, so there is the effect that design becomes easy, even in systems where subsequent image processing or rigorous synchronization timing with other equipment is required.

Further, as for the video output here, it is clear that the same effect can be obtained whether it be specified with the timing with which video images are displayed on the screen or with the output timing to external equipment. Also, in the present system, there is no need to provide a communication path for transmitting a control signal for aligning the timings of the synchronization signals other than in the network for transmission and reception of encoding signals, so it is also effective from the viewpoint of system cost reduction.

In addition, in the present embodiment, there was shown an example in which the phase of the vertical synchronization signal on the transmitter side is controlled from the receiver side, but if what is concerned is video image capture on the transmitter side and either a synchronization signal or control timing specifying the encoding timing indirectly or directly, it is clear that, by transferring phase information from the receiver side as a substitute for the vertical synchronization signal of the present embodiment, the same effect as with the present embodiment is brought about. Also, in the present embodiment, the time synchronization server had the same definition as the receiver, but the time synchronization server may be separate device that is different from the receiver. On that occasion, the receiver becomes a client, similarly to the transmitter, and after letting the server synchronize clock synchronization and the reference time counter, the same effect as with the present embodiment is brought about, if the system is devised to transmit synchronization phase information to the transmitter. At this point, it is beneficial for the case where a plurality of reception systems exist in the network and it is desired to control the same with a common clock.

In the present embodiment, there was shown an example compliant with the IEEE 802.3 Standard as the network layer standard, but it is also acceptable to further use the network protocol IP (Internet Protocol) and to use TCP (Transmission Control Protocol) and UDP (User Datagram Protocol) for higher-level transport protocols. For video and audio communication, there may further be used a high-level application protocol, such as e.g. RTP (Real-time Transport Protocol) or HTTP (Hyper Text Transfer Protocol). Alternatively, there may additionally be used a protocol method specified in the IEEE 802.3 Standard.

### Embodiment 4

The present embodiment is an example of a case where the transmitter side example described in Embodiment 3 is taken to be a plurality of cameras 1 to 3.

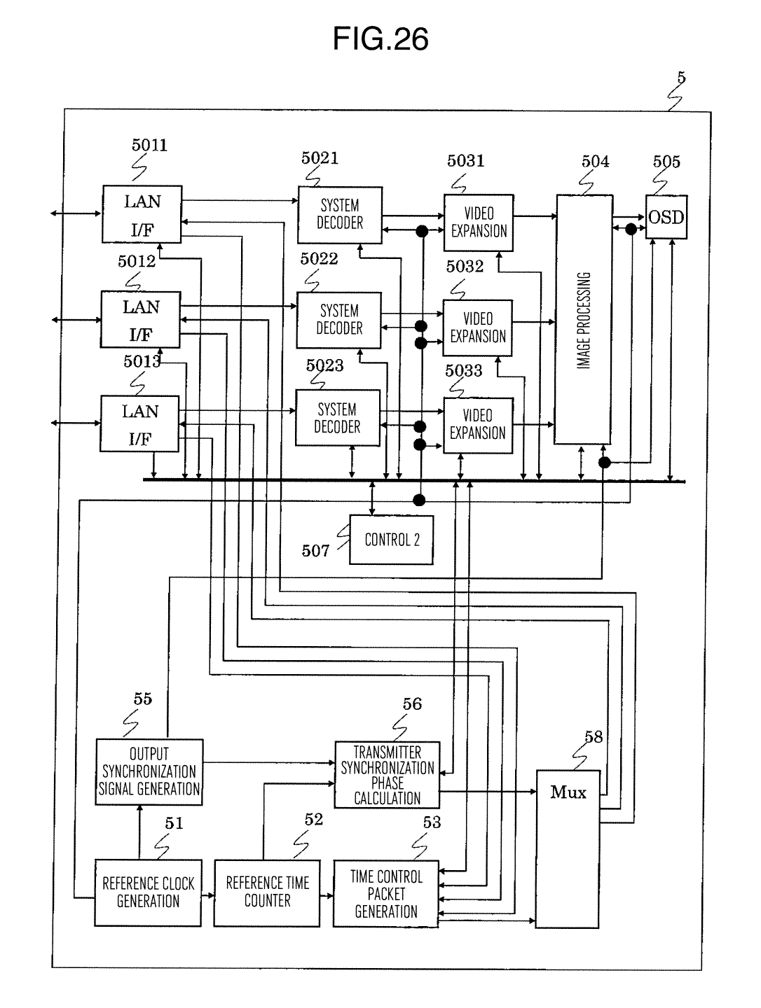

FIG. 26 is a diagram showing an example of an internal block structure of a controller 5 on the receiver side of the present embodiment. Cameras 1, 2, and 3 are respectively connected with LAN interface circuits 5011, 5012, and 5013. In reference clock generation part 51, a reference clock is generated in reference time counter 52 taking the same reference clock to be a reference, there is counted the reference time of controller 5 which is the server side. In time control packet generation part 53, there is carried out generation of packets (Sync) for time synchronization, shown in FIG. 17, using the present reference time. At the time of Sync transmission, a time T1 recorded inside the packet is generated with the present clock. The generated (Sync) packet is multiplexed with other packets in packet multiplexing part 58 and, further, is modulated in LAN interface circuits 5011, 5012, and 5013 and communicated to cameras 1 to 3 via a network connected with the outside. Besides, at the time of reception of a SyncReq packet received from cameras 1 to 3, a reception timing report is received from LAN interface circuits 5011, 5012, and 5013 and, in time control packet generation part 53, the respective times at which DelayReq packets received from cameras 1 to 3 have arrived are recorded. And then, using each time T4, DelayResp packets are generated in time control packet generation part 53 and communicated to cameras 1 to 3 via packet multiplexing part 58 and LAN interface circuits 5011 to 5013.

Again similarly to what is described above, there is carried out generation of vertical synchronization timings. Taking as a reference the reference clock generated in reference clock generation part 51, there is generated an output time vertical synchronization signal in output synchronization signal generation part 55. The present vertical synchronization signal is sent to transmitter synchronization phase calculation part 56. As described above, the phase of the vertical synchronization signal on the transmitter side is calculated from the phase of the output time vertical synchronization signal on the receiver side and, using counter information in the reference time counter, the SyncPhase packets shown in FIG. 18 are generated. The SyncPhase packets are transmitted to packet multiplexing part 58 and, similarly to the Sync packets, are transmitted to camera 1 to 3 via LAN interface circuits 5011, 5012, and 5013.

Regarding the video decoding procedure in the present embodiment, similarly to what is described above, LAN packets 60 generated in cameras 1 to 3 are respectively input into LAN interface circuits 5011 to 5013 and in LAN interface circuits 5011 to 5013, a LAN packet header 601 is removed and, according to a previously described network protocol, a transport packet 40 is extracted from LAN packet data item 602. Transport packet 40 is input into system decoders 5021 to 5023, the previously mentioned packet information items 402 are extracted from transport packet 40 and combined to become a digital compressed video signal, shown in FIG. 4. This digital compressed video signal undergoes expansion processing in video expansion circuits 5031 to 5033 and is input into image processing circuit 504 as a digital video signal. In image processing circuit 504, there is conducted distortion compensation, point of view conversion based on coordinate substitution, synthesis processing, and the like, of the video signals from each of the cameras and there is an output to OSD circuit 505, or, alternatively, there is carried out image processing such as object shape recognition and distance measurement based on the video signals from each of the cameras. In OSD circuit 505, characters and patterns in the video signal from image processing circuit 504 are weighted and are output to display 6.

Also, regarding the operation of cameras 1 to 3 in the present embodiment, as described in Embodiment 3, there is carried out processing to respectively attain time synchronization, so the times of controller 5 and cameras 1 to 3 are synchronized. In addition, SyncPhase packets are respectively received from controller 5 based on the time information thereof, a reference synchronization signal is generated. Consequently, the reference synchronization signals of cameras 1 to 3 are synchronized in the end.

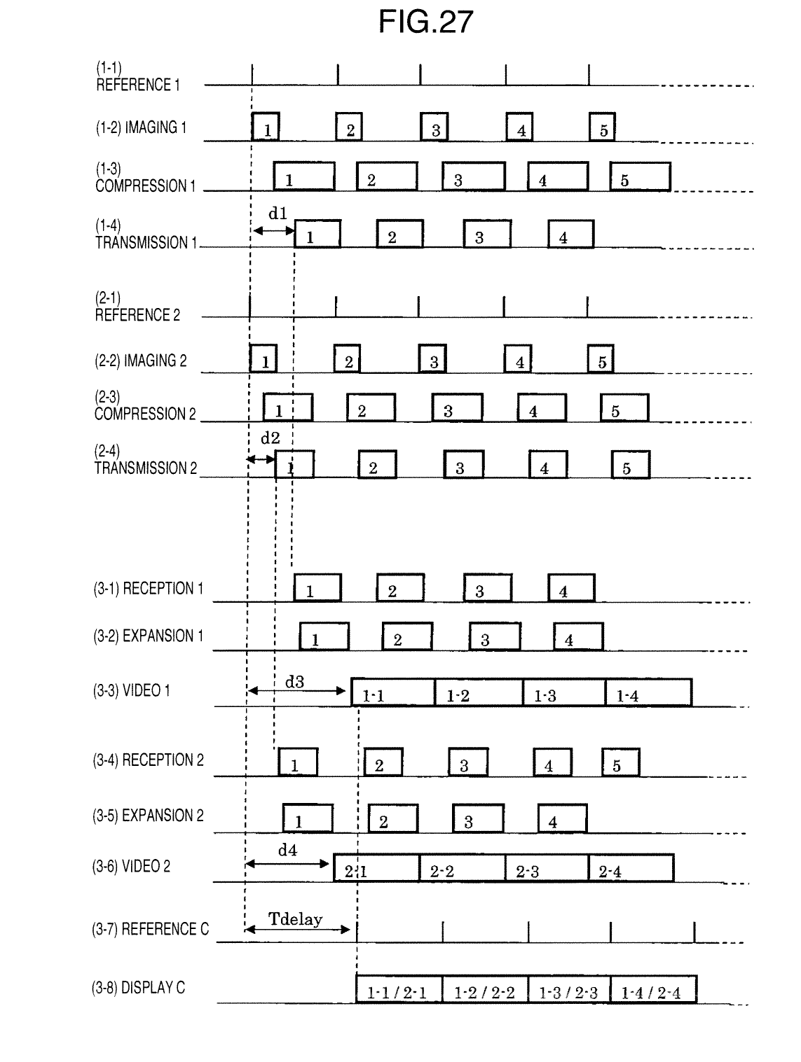

FIG. 27 is a diagram showing an example of the transmission processing timings of each of the cameras and reception processing timing of controller 5, associated with the present embodiment. In the same diagram, Refs. 1-1 to 1-4 indicate processing timings of camera 1, Refs. 2-1 to 2-4 indicate processing timings of camera 2, and Refs. 3-1 to 3-8 indicate processing timings of controller 5. As described above, since a camera having received a SyncPhase packet generates a reference synchronization signal on the basis thereof, reference signal 1 of camera 1 and reference signal 2 of camera 2 are synchronized, i.e. the frequency and phase thereof coincide. Here, d3 is the time, from reference signal 1, that it takes for a video image imaged in camera 1 to be acquired in controller 5 and d4 is the time, from reference signal 2, that it takes for a video image imaged in camera 2 to be acquired in controller 5, d3 being taken to be greater. Consequently, it comes about that the delay time Tdelay required from video capture to output for the phase difference of the vertical synchronization signals on the transmitter side and the receiver side is d3.

Here, as described above, by setting the backtracked time to be greater than d3 on the occasion of generating a SyncPhase packet, the processing timings of controller 5 work out to reference signal C 3-7 and displayed video display timing C 3-8.

According to the above, the phase difference between the vertical synchronization signals on the transmitter side and the receiver side is either equal to Tdelay or it becomes possible to adjust it in a direction approaching the same. This is to say that it becomes possible to make the total delay time approach the delay time that can be implemented with the delay time required for the communication capacity of the network and the encoding and decoding of the transmitter and the receiver.

Further, due to the fact that the imaging times in each of the cameras coincide, it becomes possible to display video images with matching display timing.

Also, since there is no need for controller 5 to absorb the display timing misalignment of video images from each of the cameras, it becomes possible to display video images with matching display timing without the processing becoming complex.

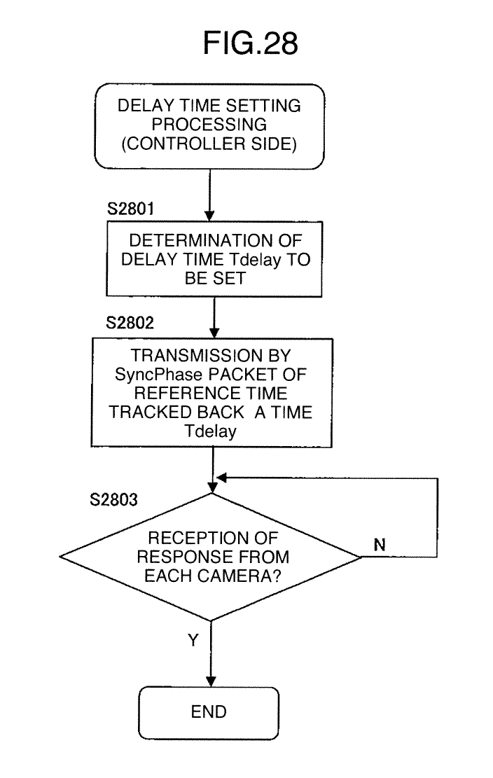

Further, as mentioned in Embodiment 1, by enquiring about the processing delay time of the respective cameras, with respect to each of the connected cameras, the shortest delay time can be implemented. Similarly to FIG. 9 of Embodiment 1, there is first made an inquiry about the processing delay times of the respective cameras, with respect to each of the cameras. In that way, each of the cameras responds with a delay time that can be set in the same camera, similarly to aforementioned FIG. 10. Next, SyncPhase packets are generated based on the processing delay time of each of these cameras. FIG. 28 is a flowchart of time information setting processing on the occasion of SyncPhase packet generation by the controller, in the present embodiment. First, a processing delay time Tdelay is determined (Step S2801). Here, the longest time among the shortest delay times of the respective cameras, obtained by the delay time acquisition processing in FIG. 9, is selected and the time found by adding thereto a delay time d5 combining network delay time Tnet and reception processing and expansion processing is taken to be reception processing delay time Tdelay. Next, controller 5 calculates the time backtracked from the Tdelay time determined in Step S2801, stores the same in a SyncPhase packet, and transmits the same to each of the cameras (Step S2802). And then, the setting result response from each of the cameras is received (Step S2803). Thereafter, each of the cameras, as described in FIG. 18 of Embodiment 3, generates a reference synchronization signal. In this way, the reference synchronization signal of each of the cameras is set to be a time which is tracked back Tdelay with respect to the reference synchronization signal of controller 5.

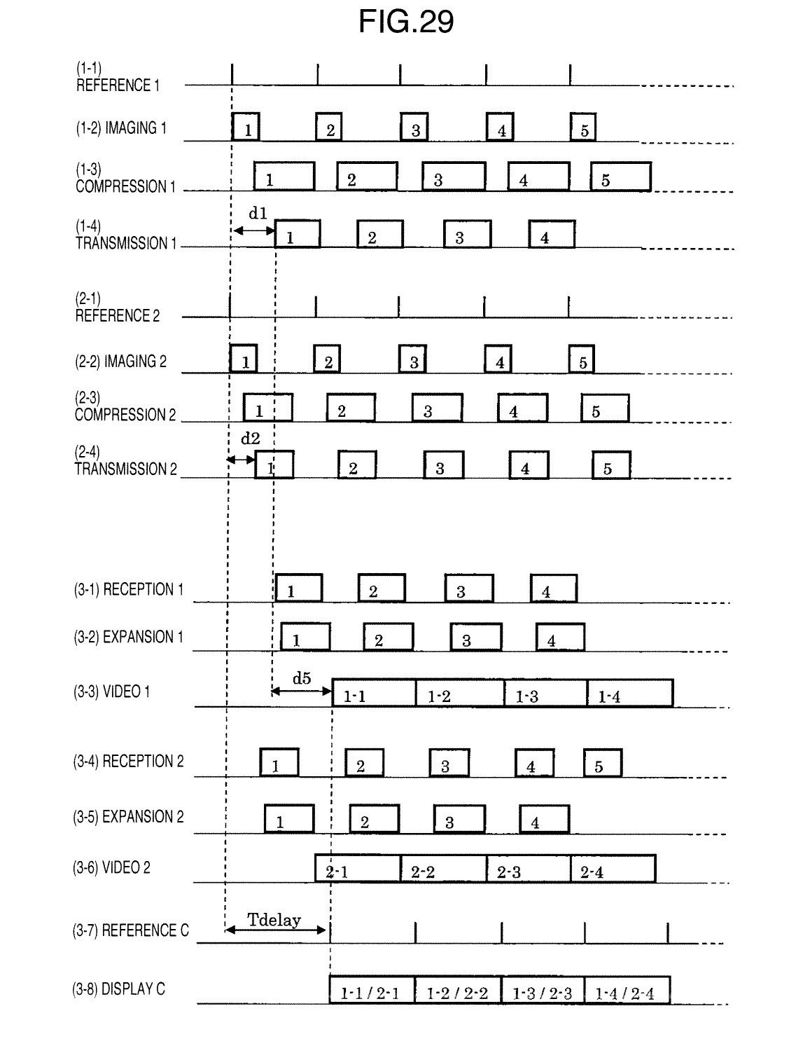

FIG. 29 is a diagram showing an example of transmission processing timing of each of the cameras and reception processing timing of controller 5 in this case. As shown in the same diagram, reference signal 1 of camera 1 and reference signal 2 of camera 2 coincide with a position obtained by tracking back, with respect to reference signal C of controller 5, a time Tdelay which is the time found by adding the longer processing time d1 from among processing delay time d1 of camera 1 and processing delay time d2 of camera 2; and processing time d5 combining network delay time Tnet, reception processing and expansion processing.

In this example, controller 5 enquired each of the cameras about the processing delay times of the respective cameras, but it is also acceptable to report to controller 5 from the side of each of the cameras, e.g. at the power-on times of the cameras or the times at which the same were connected to LAN 4.

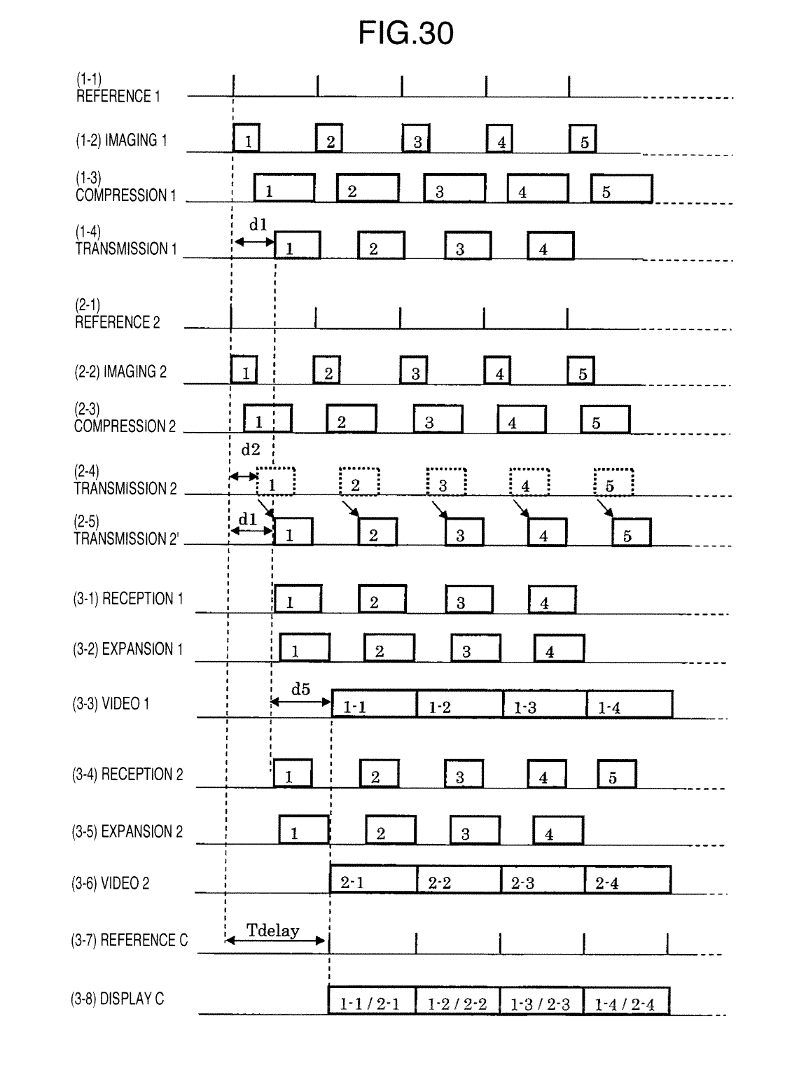

FIG. 30 is a diagram showing another example of transmission processing timing of each of the cameras and reception processing timing of controller 5. In this example, as described in Embodiment 1, controller 5 sets, with respect to camera 2, the processing delay time of camera 2 so that the processing delay time becomes d1. Ref 2-5 designates a transmission timing 2′ after the processing delay time has been set. The adjustment of the processing delay time can here e.g. be implemented by adjusting a timing read out for inputting a packet string, shown in FIG. 2, stored from system encoder 104 in packet buffer 105 into LAN interface circuit 107. In this way, the result is that transmission timing 1 of camera 1 and transmission timing 2′ of camera 2 coincide.

As described above, according to the present embodiment, it is possible, by going through a series of these control steps, to construct a network camera system in which the time from imaging up to video output becomes the imaging time with the shortest delay time that can be implemented between the connected pieces of equipment.

### REFERENCE SIGNS LIST

1, 2, 3 . . . Camera, 4 . . . LAN, 5 . . . Controller, 6 . . . Display, 100 . . . Lens, 101 . . . Imaging element, 102 . . . Video compression circuit, 103 . . . Video buffer, 104 . . . System encoder, 105 . . . Packet buffer, 106 . . . Reference signal generation circuit, 107 . . . LAN interface circuit, 108 . . . Control circuit, 201 . . . Intra frame, 202 . . . Inter frame, 301 . . . Sequence header, 302 . . . Picture header, 40 . . . Transport packet, 401 . . . Packet header, 402 . . . Packet information, 501, 5011, 5012, 5013 . . . LAN interface circuit, 5021, 5022, 5023 . . . System decoder, 5031, 5032, 5033 . . . Video expansion circuit, 504 . . . Image processing circuit, 505 . . . OSD circuit, 506 . . . Reference signal generation circuit, 507 . . . Control circuit, 60 . . . LAN packet, 601 . . . LAN packet header, 602 . . . LAN packet information, 11 . . . Packet separation part, 12 . . . Time information extraction part, 13 . . . Reference clock recovery, 14 . . . Reference time counter, 15 . . . Delay information generation part, 16 . . . Synchronization phase information extraction part, 17 . . . Reference synchronization signal generator, 18 . . . Sensor control part, 21 . . . Digital signal processing part, 24 . . . Microphone, 25 . . . A/D converter, 26 . . . Audio encoding part, 27 . . . System multiplexer, 28 . . . System control part, 51 . . . Reference clock generation part, 52 . . . Reference time counter, 53 . . . Time control packet generation part, 55 . . . Output synchronization signal generation part, 56 . . . Transmitter synchronization phase calculation part, 58 . . . Multiplexing part, 61 . . . System demultiplexing part, 63 . . . Display processing part, 64 . . . Display part, 65 . . . Audio decoding part, 66 . . . D/A conversion part, 67 . . . Speaker part

1. A video transmission device, comprising:
a reference signal generation unit which generates a reference signal based on time information;
an imaging unit which images a video signal based on a reference signal generated by means of said reference signal generation unit;
a compression unit which performs digital compression encoding of the video signal imaged by means of said imaging unit;
a network processing unit which receives, from a network, time information and reference signal phase information in regard to said time information and, also, transmits said digital compression encoded video signal; and
a control unit which controls said reference signal generation unit and said network processing unit; wherein:
said control unit controls said reference signal generation unit to modify, in response to said time information and said phase signal, received with said network processing unit, the phase of said reference signal generated with said reference signal generation unit.

2. The video transmission device according to claim 1, wherein:
said control unit reports, with respect to a video reception device, the processing time up to imaging said video signal, performs digital compression encoding thereof, and transmits the same to said network.

3. The video transmission device according to claim 2, wherein:
said control unit reports, in response to a request of said video reception device, the processing time up to imaging said video signal, performing digital compression encoding thereof, and transmitting the same to said network.

4. A video transmission method performing digital compression encoding of a video signal imaged by means of a reference signal generated based on time information; and receiving, from a network, time information and phase information of a reference signal in regard to said time information and, also, transmitting said digital compression encoded video signal; wherein:
the phase of said generated reference signal is modified in response to said time information received from the network and said phase signal.

5. A video reception device, comprising:
a reference signal generation unit which generates a reference signal based on time information;
a network processing unit which receives a data stream of one or several digital compression encoded video signals, transmitted from one or several video transmission devices connected with a network;
a decoding unit which decodes one or several of said video data items received with said network processing unit;
a video display unit which displays, based on said reference signal, video images based on one or several of said video signals decoded by means of said decoding unit; and
a control unit which controls said reference signal generation unit and said network processing unit; wherein:
said control unit controls said network processing unit to transmit, to said video transmission devices, phase information about said reference signal in regard to said time information and generated with said reference signal generation unit.

6. The video reception device according to claim 5, wherein:
said control unit acquires, from said one or several video transmission devices, processing delay time information needed for said video transmission device to image, perform digital compression encoding of, and transmit, to said network, video images.

7. The video reception device according to claim 6, wherein:
said control unit determines said phase information based on said processing delay time information acquired from said one or several video transmission devices.

8. A video reception method receiving a data stream of one or several digital compression encoded video signals transmitted from one or several video transmission devices connected with a network;
decoding said received one or several video data items; and
displaying video images based on said one or several decoded video signals, based on a reference signal generated based on time information; wherein:
phase information about said reference signal in regard to said time information is transmitted to said video transmission devices.
